(19) United States
(12) Patent Application Publication
(10) Pub. No.: US 2006/0247349 A1
(43) Pub. Date: Nov. 2, 2006

(54) Process for producing flowable, crosslinkable polyorganosiloxane compositions comprising reinforcing filler

(75) Inventors: Georg Kollmann, Burghausen (DE); Friedrich Sieglhuber, Ranshofen (AT)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/411,390

(22) Filed: Apr. 26, 2006

(30) Foreign Application Priority Data
Apr. 28, 2005 (DE) 10 2005 019 872.4

(51) Int. Cl. C08L 83/04

(52) U.S. Cl. 524/268; 525/477; 524/588

(57) ABSTRACT

The invention relates to a process for producing flowable polyorganosiloxane compositions which comprise reinforcing filler and vulcanize at room temperature or elevated temperature to produce elastomers and retain their flowability on addition of polar additives.

### BACKGROUND OF THE INVENTION

1. Field of the Invention

The invention relates to a process for producing flowable polyorganosiloxane compositions which comprise reinforcing filler and which vulcanize at room temperature or elevated temperature to produce elastomers, and which retain their flowability on addition of polar additives.

2. Background Art

Flowable silicone rubber compositions are used in many applications, i.e. as casting compositions for producing elastic negative molds and also moldings such as printing pads, cable fittings, etc. Owing to the relatively high mechanical demands placed on such molds and moldings, compositions comprising reinforcing fillers are usually used. These reinforcing fillers are predominantly precipitated or pyrogenic silicas having a specific surface area (BET) of >40 m²/g.

If hydrophilic, i.e. untreated, silica is mixed with relatively long-chain (n>50) siloxane polymers, pronounced filler-polymer interactions which are based essentially on hydrogen bonds between the SiOH groups on the silica surface and the oxygen atoms of the polysiloxane chains occur. Since a relatively long polymer chain can interact with a plurality of filler particles, the result is not only the desired reinforcing action due to fixing of polymer chains on the surface of the individual filler particles but also pseudocrosslinking (“structure formation”) and consequently insufficiently flowable and storage-stable polymer/filler dispersions. For this reason, the surface of the silica has to be modified in an appropriate way. Among the numerous treatment agents which are described as fundamentally suitable in the literature, and known to those skilled in the art, silicon compounds having Si—Cl, Si—N, Si—H, SiOH and Si—OR functions, sometimes in combination with additional catalysts, are most widely used, with the silica either being treated in a separate process and subsequently mixed with the silicone polymer or treated “in situ” in the presence of the silicone polymer. Those skilled in the art know that the use of pretreated silica without additional in-situ treatment generally leads, at the same filler content, to compositions which flow less readily compared to the pure in-situ process. However, even in the in-situ process, the many possible influencing parameters such as type and amount of treatment agent, temperature conditions, manner of introduction of the silica, shear, removal of volatiles, etc., have to be optimized to obtain the desired result, which often proves to be difficult.

There are in principle two possible methods of treating hydrophilic silicas:
A) Reaction of the SiOH groups on the silica surface with an essentially stoichiometric amount of a monomeric or oligomeric treatment agent with the objective of converting them predominantly into relatively sterically small, nonpolar groups which are thus no longer capable of undergoing interactions.
B) Shielding of the SiOH groups by occupation of the silica surface with relatively short-chain oligoorganosiloxanes or polyorganosiloxanes (to keep the bridging tendencies between the filler particles low) which are anchored and fixed to the filler surface by reaction or/and via hydrogen bonds.

Processes such as A) or B) described above, or a combination of A) and B), representing the state of the art, provide silicone rubber compositions which have satisfactory flowability, storage stability, and also mechanical strength, especially tensile and tear strength. However, this generally applies only if polar additives are not required. If the use of such additives is necessary to give the rubber particular properties, for example by surface-active substances such as antistatic or hydrophilic modifiers, functional silanes, for example bonding agents; or phenylsilicone oils, often used as media which bleed out, for example to produce separation, anti-friction or hydrophobic effects, then these can interact both with sterically accessible SiOH groups still present on the silica surface and with residues of polar treatment agents or their reaction products still present in the system as a result of the process, which causes a thickening or thixotropic effect which can go as far as to lead to a non-sag consistency of the originally flowable rubber composition.

There have been many attempts to achieve the necessary compromise between flowability, storage stability, mechanical strength and tolerance to structuring additives by selection of suitable treatment agents or process parameters.

It is known that when employing the silazanes most frequently used for silica treatment, in general hexamethyldisilazane, polyorganosiloxane/silica preparations produced by customary methods as described, for example, in the U.S. Pat. No. 3,243,404, lose their flowability on addition of polar additives, which is attributed firstly to the lack of shielding effect of the relatively small trimethylsiloxy groups on the strongly rugged silica surface and secondly to the formation of polar reaction products such as trimethylsilanol and amines.

European patent application EP 1 171 079 A1 discloses an addition-crosslinking polyorganosiloxane composition comprising pyrogenic silica as a reinforcing filler, and a wetting agent which comprises one or more surface-active agents which give the silicone surface a hydrophilic character. The silicone material is said to be particularly suitable as a dental molding composition and offers a compromise between flowability in the uncrosslinked state, hydrophilicity in the uncrosslinked and crosslinked state and higher mechanical strength in the crosslinked state. The treatment process described in this patent application for silica is identical to the process claimed in the European patent application EP 0 991 712 A1.

International patent application WO 2002/102326 A1 discloses an addition-crosslinking polyorganosiloxane composition which comprises pyrogenic silica as a reinforcing filler and nonionic surfactants which give the silicone rubber surface hydrophilic and/or antistatic properties. The silicone material is particularly suitable as a dental molding composition, as a molding composition for reproduction of dental castings, and for producing printing pads and copying rollers. Although a silica pretreated with octamethylcyclotetrasiloxane is used in the examples, the description indicates that if good flowability is required, it is advantageous to treat the silica by the process corresponding to the European patent application EP 0 991 712 A1.

The silicone materials from the two abovementioned patent specifications EP 1 171 079 A1 and WO 2002/102326 A1 have, despite the addition of polar additives in the required effective concentration, satisfactory flowability, which is achieved by a specific in-situ treatment process for the pyrogenic silica which is then introduced in the form of a polymer/filler suspension into these finished compositions. This process is disclosed in European patent application EP 0 991 712 A1 and the suspension there disclosed is suitable for producing addition-crosslinking silicone compositions, wherein the treatment is carried out in at least two steps, in which the silicone material or a partial amount thereof, water and all of the filler or a partial amount thereof are mixed with a first partial amount of the total treatment agent in an amount of less than 8%, preferably less than 5% and most preferably less than 3%, based on the dry weight of the filler, and a second partial amount of the total treatment agent in an amount of 5-25% by weight, preferably 10-20% by weight, based on the dry weight of the filler, is then mixed in. The examples indicate that the treatment agent is preferably a silazane, most preferably hexamethyldisilazane (HMDS), but not only HMDS but also bifunctional or preferably monofunctional siloxanes bearing hydroxyl groups, amines, preferably ammonia, and/or alkylamines, most preferably diethylamine, or organic acids, preferably formic or acetic acid, alone or in admixture with one another, as alternative treatment agents can be used in the first treatment step.

European patent EP 1 141 108 B1 discloses a similar process for producing silicone compositions which can crosslink by polycondensation, wherein the particulate, reinforcing filler is treated with the aid of a compatibilizer by adding a partial amount of the treatment agent corresponding to 8-30% by weight of the dry weight of the filler before and/or approximately simultaneously with the introduction of at least a partial amount of the silicon matrix used and of the particulate, reinforcing filler used, which comprises 10-50% by weight of a polyorganosiloxane, and adding the second partial amount which corresponds to from 2 to 25% by weight of the dry weight of the filler after introduction of the filler into at least a partial amount of the silicone matrix. Compatibilizers claimed are exclusively organosilazanes or cycloorganosilazanes which are liquid under normal conditions, but preferably hexamethyldisilazane.

Both process variants claimed require at least one treatment agent which is to be prepared and used separately, preferably hexamethyldisilazane, if appropriate in combination with divinyltetramethyldisilazane, in a total amount of at least 5% by weight, but preferably above 10% by weight, based on the dry weight of the silica, with the addition having to be carried out in at least two steps. Even when, as claimed in the patent specifications EP 1 171 079 A1 and EP 0 991 712 A1, one of the alternative treatment agents mentioned is used in the first treatment step, hexamethyldisilazane is always used in the second treatment step and thus as predominant part of the total amount of treatment agent. The reaction products trimethylsilanol, ammonia and possibly amines have to be removed absolutely completely if polar additives are added and flowable compositions are nevertheless to be achieved, which requires particularly time-consuming and costly heating steps. If diethylamine is used, there is also a tendency for yellowing to occur and the risk of formation of carcinogenic nitrosamines by reaction with nitrogen oxides which are ubiquitous nowadays.

Among the in-situ treatment agents mentioned under B), the most widely used by far are bifunctional and sometimes also monofunctional siloxanes bearing hydroxyl groups:

The use of SiOH-containing silanes or siloxanes as treatment agents for pyrogenic silica is described, for example, in the U.S. Pat. No. 2,890,188 which claims 100 parts by weight of a benzene-soluble polymer having a viscosity of ≧10,000 mPa·s, 1-100 parts by weight of an organosil(ox)ane having an SiOH content of 3300-370,000 ppm, 10-90 parts by weight of fumed silica, and 1-10 parts by weight of a vulcanization agent, preferably an organic peroxide. The objective is to produce storage-stable compositions which lead to vulcanizates having increased mechanical strength.

U.S. Pat. No. 5,118,754 discloses addition-crosslinking silicone rubber compositions comprising pyrogenic silica, for which a cyclic polyorganosiloxane having four R₂SiO units and at least one vinyl group and one hydroxyl group per molecule, or a linear polyorganosiloxane having at least one hydroxyl group and, on average, one vinyl group per molecule and a mean chain length of n=4-50, in a proportion of 1-20 parts by weight per 100 parts by weight serves as treatment agent, with the silica either being additionally hydrophobicized in situ with hexamethyldisilazane or else silica which has been prehydrophobicized with hexamethyldisilazane is used. The objective is to produce storage-stable compositions which are suitable for injection molding and whose vulcanizates have improved fatigue resistance.

European Patent EP 491 598 B1 discloses an addition-crosslinking silicone rubber composition comprising pyrogenic silica and the process for producing it, wherein a specific low molecular weight, OH-functional treatment agents of the formula (CH₃)₃SiO(HO)(R¹)SiOSi(R¹)(OH)OSi(CH₃)₃ or (CH₃)₃SiO(HO)(R¹)SiOSi(CH₃)₃ (R1=methyl, trimethylsiloxy, vinyl or trifluoropropyl) are used either alone or in combination, and in addition, a condensation catalyst selected from among NH₃, NH₄OH, an ammonium salt, a phosphorus siliconate, a potassium siliconate, or tin, titanium and zinc compounds is used. The objective is to produce flowable rubber compositions for the production of molds having improved release properties for casting resins.

U.S. Pat. No. 5,674,935 discloses a process for the in-situ treatment of reinforcing filler, in which a composition comprising a vulcanizable silicone or fluorosilicone polymer, pyrogenic silica and about 1-10 parts by weight of a treatment agent of the formula HO[(CH₂═CH)(R)SiO]ₐ[(R)(R¹)SiO]_{b}[(R)(R²)SiO]_{c}H and having a viscosity of about 80-1000 mPa·s is mixed at a temperature of about 60-100° C. under shear until the reaction between filler and treatment agent is complete and is subsequently heated at about 200° C. The vulcanization in the examples is carried out by means of organic peroxides throughout. The treatment agent additionally serves as crosslinker. The objective is the production of high-temperature vulcanizing rubber compositions which nevertheless offer good mechanical properties at a reduced proportion of reinforcing filler.

The abovementioned processes serve either to produce rubber compositions which are a priori not flowable, of very high viscosity and able to be processed only by compression or extrusion processes, or which require separate treatment agents which can be prepared only with difficulty. In the case of the flowable compositions, addition of polar additives is not described.

A further filler treatment method is the polymerization/equilibration of relatively low molecular weight polyorganosiloxanediols, if appropriate in combination with organocyclosiloxanes, to form higher molecular weight polyorganosiloxanes in the presence of reinforcing filler.

U.S. Pat. No. 3,477,988 discloses a process for the alkaline polymerization/equilibration of polyorganosiloxanes starting from either low molecular weight organocyclosiloxanes to produce high molecular weight polyorganosiloxanes, or from relatively high molecular weight polyorganosiloxanes to produce relatively low molecular weight polyorganosiloxanes, if desired in the presence of pyrogenic silica, water and optionally chain stoppers, wherein an organophosphorus compound, preferably, inter alia, triethyl phosphate, hexamethylphosphoramide, tributylphosphine oxide or trioctylphosphine oxide, is used as promoter (activator, cocatalyst) in addition to previously known alkaline polymerization and equilibration catalysts. Particular advantages of the use of the claimed promoters are said to be that they inhibit silanol condensation even in the presence of active basic condensation catalysts, and that fillers such as silica can be present without hindering the polymerization/equilibration. The objective is, providing catalyst/promoter systems having an increased activity for the polymerization of low molecular weight organosiloxanes or the degradation of high molecular weight crosslinked, filler-containing or uncrosslinked polyorganosiloxanes, not in-situ treatment of silica.

British Patent GB 1,325,657 discloses a process for polymerizing low molecular weight organocyclosiloxanes in which n≧2, optionally in admixture with linear organosiloxanes in which n=1-20, in the presence of acidic or neutral pyrogenic silica, with at least 0.05% of a water-free perfluoroalkanesulfonic acid, based on the total organosiloxane, being used as polymerization catalyst. Neutralization is preferably carried out using hexamethyldisilazane or zinc carbonate. The objectives are the provision of a polymerization catalyst which is active even in the presence of acidic fillers and the production of high molecular weight polyorganosiloxanes comprising reinforcing filler.

European Patent EP 0 119 093 B1 discloses a process for the polymerization of an α,ω-hydroxypolydiorganosiloxane in the presence of inactive or active filler, in which an organosiloxane of the formula HO(R₂SiO)ₓH (x=3-200) is mixed with the filler with additional use of a condensation catalyst of the formula MO(R₂SiO)_{z}Q, where M is an alkali metal or a tetraalkylammonium or tetraalkylphosphonium group, Q is an alkali metal, a tetraalkylammonium or tetraalkylphosphonium group or hydrogen and z≧1, the water is subsequently removed from the mixture by heating at a temperature below the decomposition point of the catalyst, and the catalyst is subsequently deactivated, wherein the silicone polymer formed has a higher molecular weight than the starting organosiloxane. A preferred catalyst, apart from tetra-n-butylphosphonium dimethylsilanolate, where deactivation proceeds by heating above the decomposition temperature, is potassium diorganosilanolate where deactivation is carried out by means of a weak acid, preferably CO₂. The polymer/filler mixtures can serve as the basis of peroxide-crosslinking, condensation-crosslinking and addition-crosslinking composition.

European Patent EP 0 120 645 B1 discloses a process for the polymerization of organosiloxanes of the formula HO(R₂SiO)ₓH (x=3-50) and/or (R₂SiO)_{y} (y=3-10), optionally in the presence of organosiloxanes of the formulae R₃SiO(R₂SiO)_{z}SiR₃ and/or R₃SiO(R₂SiO)ₙH (z=0-50) as chain stoppers, in the presence of an acidic or neutral reinforcing filler, with trifluoromethanesulfonic acid being used as polymerization catalyst. Neutralization is ultimately carried out using a Lewis base, preferably calcined magnesium oxide. The polymer/filler mixtures can serve as the basis of peroxide-crosslinking, condensation-crosslinking and addition-crosslinking compositions.

U.S. Pat. No. 4,482,670 discloses a process for the polymerization of organosiloxanes of the formula HO(R₂SiO)ₓH (x=3-100), optionally in the presence of organosiloxanes of the formulae R₃SiO(R₂SiO)ₙSiR₃ and/or R₃SiO(R₂SiO)_{z}H (z=0-50) as chain stoppers, in the presence of an acidic or neutral reinforcing filler, wherein the silicone polymer formed has a higher molecular weight than the starting organosiloxane, with sulfuric acid or a sulfonic acid of the formula XSO₃H (X=halogen, alkyl, aryl, alkoxy or aralkyl) being used as polymerization catalyst. Neutralization is carried out using a Lewis base, preferably calcined magnesium oxide or diethylamine. The polymer/filler mixtures can serve as the basis of peroxide-crosslinking, condensation-crosslinking and addition-crosslinking compositions.

U.S. Pat. No. 4,486,567 discloses a process for the polymerization of organosiloxanes of the formula HO(R₂SiO)ₓH (x=3-50), optionally in the presence of organosiloxanes of the formula R₃SiO(R₂SiO)_{z}H (z=0-50) as chain stoppers, in the presence of an acidic or neutral reinforcing filler with removal of the water formed in the reaction, wherein the silicone polymer formed has a higher molecular weight than the starting organosiloxane, with a quaternary ammonium carboxylate of the formula R₄¹NOC(O)R², preferably lauryltrimethylammonium acetate, in combination with a carboxylic acid of the formula R²COOH, preferably acetic acid, being used as polymerization catalyst. Catalyst deactivation is effected by heating to 150-200° C. The polymer/filler mixtures can serve as the basis of peroxide-crosslinking, condensation-crosslinking and addition-crosslinking preparations.

European Patent EP 0 205 964 B1 discloses a continuous kneader process for producing silicone polymer/filler mixtures by polymerization of organosiloxanes of the general formula HO(R₂SiO)ₓH (x=3-100) or (R₂SiO)_{y} (y=3-10) or mixtures thereof, if appropriate including organosiloxanes of the formulae R₃SiO(R₂SiO)_{z}SiR₃ or R₃SiO(R₂SiO)_{z}H (z=0-50) as chain stoppers, in the presence of 1-150 parts by weight of filler and 0.02-10 parts by weight of a polymerization catalyst which is effective in the presence of the filler and is selected from among sulfuric acid, sulfonic acids of the formula XSO₃H (where X is halogen, alkyl, aryl, alkoxy or aralkyl), perfluorinated alkanesulfonic acids, phosphoric acid, activated clay and combinations of carboxylic acids and a quaternary ammonium carboxylate in the case of acidic or neutral fillers and sodium hydroxide, potassium hydroxide, potassium dimethylsilanolate and tetrabutylsulfonium dimethylsilanolate in the case of basic fillers. Catalyst deactivation is effected by neutralization. The polymer/filler mixtures can serve as the basis of peroxide-crosslinking, condensation-crosslinking and addition-crosslinking preparations.

All the abovementioned processes in principle start out from low molecular weight or very high molecular weight to crosslinked polyorganosiloxanes which are transformed into the final polymers which are required for the desired vulcanization properties and have the chain lengths and molecular weights necessary for these only in situ in the presence of the reinforcing filler, by addition of polymerization/equilibration catalysts, with or without chain stoppers. Those skilled in the art know that such polymerization/equilibration processes for producing organosiloxane polymers having particular molecular weight distributions, i.e. chain length distributions, are complicated and difficult to control with respect to catalyst selection and deactivation in the process, even in the absence of active fillers. The achievement of reproducible polymer properties under the conditions of simultaneous filler incorporation and treatment are expected to be even more critical. There is therefore a need for a method of treating reinforcing fillers in the presence of organosiloxane polymers which avoids the abovementioned disadvantages.

### SUMMARY OF THE INVENTION

It is an object of the present invention to provide a process for producing homogeneous mixtures of polyorganosiloxanes and reinforcing fillers by means of in situ treatment of the filler, with the polymer/filler mixtures obtained being suitable for producing polyorganosiloxane preparations. One objective of the present invention is therefore a simple, inexpensive and reproducible process for producing such polymer/filler mixtures. A preferred objective of the present invention is a process for producing polymer/filler mixtures which are suitable for the formulation of flowable, crosslinkable polyorganosiloxane preparations having satisfactory storage stability, with the vulcanizates produced therefrom having increased mechanical strength.

A particularly preferred objective of the present invention is a process for producing polymer/filler mixtures which are suitable for the formulation of flowable condensation- or addition-crosslinking silicone rubber preparations which can be crosslinked at room temperature and have satisfactory storage stability, and for which addition of polar additives in an effective amount does not lead to loss of flowability due to viscosity increase or thixotropy.

### DETAILED DESCRIPTION OF THE PREFERRED EMBODIMENT(S)

The present invention accordingly provides a flowable, crosslinkable polyorganosiloxane composition comprising
(A) at least one suspension of reinforcing fillers in polyorganosiloxane(s),
(B) at least one crosslinking system selected from the group consisting of condensation- and addition-crosslinking systems,
(C) at least one corresponding crosslinking catalyst,
(D) optionally one or more polar additives, and
(E) optionally further additives,
wherein the suspension (A) is obtained by
(1) mixing of
   (X) polyorganosiloxane(s) having a viscosity at 23° C. of from 100 to 500,000 mPa·s or a mixture of such polyorganosiloxanes with
   (Y) water, with the proviso that the total amount of water added can be introduced into the mixture either separately or else, in part or in total as a constituent of the condensation/equilibration catalyst (Z) or, in adsorbed state, via a reinforcing filler (F) and
   (Z) at least one substance effective as a condensation/equilibration catalyst or a mixture of such substances,
(2) optionally equilibrating the mixture at elevated temperature, preferably from 50° C. to 180° C., for a period of from 15 to 120 minutes,
(3) adding a reinforcing filler (F) having a specific surface area (BET) of at least 40 m²/g,
(4) reacting the mixture at elevated temperature, preferably from 50° C. to 180° C.,
(5) deactivating the catalyst (Z) by addition of one or more deactivating agents (DA),
(6) removing volatile constituents by heating in a stream of inert gas and/or under reduced pressure in the temperature range from 80° C. to 180° C. and
(7) optionally adding further polysiloxane (XX) or mixture thereof.

The present invention further provides a process for producing flowable, crosslinkable polyorganosiloxane compositions comprising
(A) at least one suspension of reinforcing fillers in polyorganosiloxanes,
(B) at least one crosslinking system selected from the group consisting of condensation- and addition-crosslinking systems,
(C) at least one corresponding crosslinking catalyst,
(D) optionally one or more polar additives, and
(E) optionally further additives,
   wherein the suspension (A) is obtained by
(1) mixing of a
(X) polyorganosiloxane having a viscosity at 23° C. of from 100 to 500,000 mPa·s or a mixture of such polyorganosiloxanes with
(Y) water, with the proviso that the total amount added can be introduced into the mixture either separately or else, in part or in total as a constituent of the condensation/equilibration catalyst (Z) or, in the adsorbed state, via the reinforcing filler (F) and
(Z) a substance effective as condensation/equilibration catalyst or a mixture of such substances,
(2) optionally equilibrating the mixture at elevated temperature, preferably from 50° C. to 180° C., for a period of from 15 to 120 minutes,
(3) adding a reinforcing filler (F) having a specific surface area (BET) of at least 40 m²/g,
(4) reacting the mixture at elevated temperature, preferably from 50° C. to 180° C.,
(5) deactivating the catalyst (Z) by addition of one or more deactivating agents (DA),
(6) removing volatile constituents by heating in a stream of inert gas and/or under reduced pressure in the temperature range from 80° C. to 180° C. and
(7) optionally adding of a further polysiloxane (XX) or a mixture thereof.

The polyorganosiloxanes (X) which serve as a constituent of the suspension (A) comprise units of the general formula (I)
RₐSiO_{(4-a)/2} (I)
where
the radicals R are identical or different monovalent, Si—C-bonded, substituted or unsubstituted C₁-C₁₈-hydrocarbon radicals or a hydroxyl radical and
a is 0, 1, 2 or 3, on average 1.85-2.4, preferably 1.9-2.1,
with the proviso that R is not a radical which is reactive in the presence of the condensation/equilibration catalyst used if these radicals are present in a concentration of >1000 ppm, preferably >700 ppm, based on the total amount of the polyorganosiloxanes (X).

Examples of radicals R are alkyl radicals such as methyl, ethyl, n-propyl, i-propyl, n-butyl, i-butyl, t-butyl, n-pentyl, i-pentyl, neopentyl, t-pentyl, hexyl (for example n-hexyl), heptyl (for example n-heptyl), octyl (for example n-octyl; i-octyl, for example 2,2,4-trimethylpentyl), nonyl (for example n-nonyl), decyl (for example n-decyl), dodecyl (for example n-dodecyl), and octadecyl (for example n-octadecyl); radicals alkenyl radicals such as vinyl, allyl, n-propenyl, i-propenyl, n-butenyl, and alkenyloxy radicals; cycloalkyl radicals such as cyclopentyl, cyclohexyl, cycloheptyl and methylcyclohexyl radicals; cycloalkenyl radicals such as the cyclohexenyl radical; aryl radicals such as the phenyl, naphthyl, anthryl, and phenanthryl radicals; alkaryl radicals such as the o-, m-, p-tolyl, xylyl, and ethylphenyl radicals; and aralkyl radicals such as the benzyl, and the α- and β-phenylethyl radicals.

Examples of substituted radicals R are cyanoalkyl radicals such as the β-cyanoethyl radical; haloalkyl radicals such as the 3,3,3-trifluoro-n-propyl, 2,2,2,2′,2′,2′-hexafluoro-1-propyl, heptafluoro-i-propyl, chloromethyl, and bromoethyl radicals; and haloaryl radicals such as the o-, m-, and p-chlorophenyl radicals.

The polyorganosiloxanes (X) have a viscosity at 23° C. of from 100 to 500,000 mPa·s, preferably from 500 to 50,000 mPa·s, and most preferably from 1000 to 20,000 mPa·s.

As polyorganosiloxanes (X), preference is given to using polydiorganosiloxanes of the general formula (II)
(R¹)ₓ(R²)₃₋ₓ SiO[Si(R²)₂O]ₘ [Si(R²)(R¹)O]ₙ Si(R²)₃₋ₓ(R¹)ₓ (II)
where
the radicals R¹ are identical or different monovalent, SiC-bonded, unsaturated C₁-C₈-alkyl radicals, the radicals R² are identical or different monovalent, SiC-bonded, substituted or unsubstituted saturated C₁-C₈-alkyl radicals, substituted or unsubstituted C₁-C₈-aryl radicals, or the hydroxyl radical,
m is from 100 to 1200, preferably from 150 to 700, most preferably from 200 to 500,
n is 0 or from 1 to 50, and
x is 0 or from 1 to 3

In addition to the diorganosiloxane units [Si(R²)₂O] and [Si(R²)(R¹)O], other siloxane units can also be present within or along the polysiloxane chains of the general formula (II). Examples of such other siloxane units are those of the formulae (R²SiO_{3/2}), (R²₃SiO_{1/2}) and SiO_{4/2}, where R² is in each case as defined above. However, the proportion of such siloxane units other than diorganosiloxane units is preferably not more than 10 mol %, in particular not more than 1 mol %, in each case based on the weight of polydiorganosiloxane (X).

Examples of monovalent, SiC-bonded, unsaturated C₁-C₈-alkenyl radicals R¹ are alkenyl radicals such as the vinyl, allyl, cyclohexenyl, and alkenyloxy radicals, preferably the vinyl radical. Preferred examples of radicals R² are methyl, phenyl and 3,3,3-trifluoro-n-propyl, most preferably methyl. the value of x is preferably 0 or 1, and n is preferably 0 or from 1 to 5, more preferably 0, i.e. particular preference is given to trimethylsiloxy radicals and vinyldimethylsiloxy radicals at the ends of the chains.

As polyorganosiloxane (X), it is possible to use one type of polydiorganosiloxane (II) or a mixture of at least two different types of polydiorganosiloxane (II).

The constituent water (Y) serves, in combination with the condensation/equilibration catalyst (Z) to convert the polyorganosiloxane (X) in-situ into polyorganosiloxanes (H) which, in one molecule, have at least one hydroxyl radical bound directly to a silicon atom, with the hydroxyl radicals being produced by catalytic cleavage of the polyorganosiloxane chains of (X). The catalytic depolymerization/equilibration of polyorganosiloxanes in the presence of H₂O is known and described, for example, in Noll, W., Chemie und Technologie der Silicone, Verlag Chemie, Weinheim, 2nd edition 1964, pp. 200-206 [Chemistry and Technology of Silicones, Academic Press, New York].

The polyorganosiloxanes (H) having at least one hydroxyl radical bound directly to a silicon atom in a molecule subsequently serve as treatment agent for the reinforcing filler by reaction of their SiOH groups with the SiOH groups present on the surface of the filler by condensation with elimination of water to form covalent bonds. These chemical bonds and additional intermolecular interactions between the free electron pairs of the oxygen atoms in the polyorganosiloxane chains and further SiOH groups present on the surface of the filler result in fixing of the polyorganosiloxane chains to the surface of the filler, with the latter being shielded against interactions with substances bearing polar groups.

The total amount of polyorganosiloxane (H) required for sufficient shielding of the surface of the active filler (F) present in the suspension (A) naturally depends on the amount of (F) added and on its BET surface area.

The total amount of polyorganosiloxane (H) formed in situ by hydrolytic cleavage of the polyorganosiloxane (X) in the presence of the catalyst (Z) and available for the treatment of the active filler (F) present in the suspension (A) is, provided the catalyst concentration is sufficient, determined essentially by the amount of available reactant water.

The total amount of water (Y) available for producing the total amount of polyorganosiloxane (H) required for sufficient treatment of the filler is made up of the amount of added water, which can be introduced into the mixture either separately or else, all or in part as a constituent of the condensation/equilibration catalyst (Z) or, in the adsorbed state, via the reinforcing filler (F), and the amount of water of condensation formed in the reaction of the SiOH groups of the polyorganosiloxane (H) with the SiOH groups present on the surface of the active filler (F).

Since the major part of the polyorganosiloxane (H) required for treatment of the filler is formed simultaneously in situ in the presence of the condensation/equilibration catalyst (Z) from the water produced in the treatment reaction, a relatively low initial concentration of polyorganosiloxane (H) containing hydroxyl groups in the polyorganosiloxane (X) at the beginning of the introduction of the filler is sufficient.

The introduction of an amount of reinforcing filler which is sufficient for the desired reinforcing action into the initially charged polyorganosiloxane (X) and its complete treatment generally requires, in addition to the amount of water adsorbed on the surface of the filler of on average 0.2% by weight, the addition of 0.05-1.5% by weight of H₂O, preferably 0.1-1% by weight of H₂O, more preferably 0.25-0.65% by weight of H₂O, in each case based on the amount of reinforcing filler (F) added, with the addition being able to be carried out separately or as constituent of the condensation/equilibration catalyst (Z).

Substances suitable as condensation/equilibration catalyst (Z), i.e. both for the cleavage of the polyorganosiloxane chains of (X) and for the condensation of the hydroxyl groups formed in the presence of H₂O on the polyorganosiloxane (H) with the SiOH groups of the reinforcing filler (F), have been known to those skilled in the art for a long time and have been described, apart from in the above-cited patent documents, for example in W. Noll, CHEMIE UND TECHNOLOGIE DER SILICONE, Verlag Chemie, Weinheim, 2nd edition 1964, pp. 200-206 and 181-185.

There is in principle no technical restriction in the choice of the catalyst (Z) as long it is sufficiently reactive under the chosen conditions to make possible both the hydrolytic cleavage of the chains of the polyorganosiloxane (X) to the extent required for complete treatment and also the condensation of the hydroxyl groups on the polyorganosiloxane (H) formed with the SiOH groups on the surface of the reinforcing filler (F).

It is possible to use both acidic and alkaline catalysts, but preference is given to using catalysts which, under the chosen conditions have, first, a very low depolymerization action and consequent tendency to form low molecular weight polyorganocyclosiloxanes and, second, predominantly promote the condensation of the hydroxyl groups on the polyorganosiloxane (H) formed with the SiOH groups on the surface of the reinforcing filler (F) over the condensation of the hydroxyl groups bound to polyorganosiloxane with one another to lead to an increase in the molecular weight.

An excessive depolymerization reaction would naturally alter the properties of the original polyorganosiloxane (X) too much with respect to its network-forming properties for the polyorganosiloxane compositions produced from the suspensions (A) to be able to display the properties which were to be obtained by targeted selection of (X).

Excessive condensation of the hydroxyl groups bound to polyorganosiloxane with one another and the associated molecular weight increase would increase the viscosity of the suspension to such an extent that it would no longer be possible to formulate sufficiently flowable polyorganosiloxane compositions from the suspensions (A).

Examples of catalysts (Z) which are suitable include carboxylic acids, optionally in combination with their quaternary ammonium salts, sulfonic acids of the general formula XSO₃H, where X is alkyl, aryl, alkaryl or halogen, secondary and tertiary alkylamines, alkylsulfonium silanolates, alkali metal oxides, hydroxides, alkoxides, silanolates, quaternary ammonium and phosphonium compounds, etc. Preferred catalysts (Z) for the process of the invention are alkali metal oxides, hydroxides, alkoxides and silanolates, most preferably sodium hydroxide, potassium hydroxide, sodium trimethylsilanolate and potassium trimethylsilanolate.

To ensure a concentration of hydroxyl-comprising polyorganosiloxane (H) sufficient for the treatment of the reinforcing filler (F) in the incorporation time, an amount of condensation/equilibration catalyst (Z) of 0.05-5% by weight, preferably 0.1-3.5% by weight, and most preferably 0.5-2.5% by weight, in each case based on the total amount of reinforcing filler (F) added, is generally required. The concentration of hydroxyl-comprising polyorganosiloxane (H) available for the treatment of the reinforcing filler (F) at the beginning of the addition of the reinforcing filler (F) depends not only on the type and amount of the condensation/equilibration catalyst (Z) but also on the temperature of the mixture of polyorganosiloxane (X), water (Y) and catalyst (Z) and the time over which the catalyst acts on the polyorganosiloxane/water mixture.

If the SiOH content of the polyorganosiloxane (X) is below 100 ppm and/or the proportion of reinforcing filler (F) to be treated is more than 30% by weight, based on the polyorganosiloxane (X), and/or (F) has a moisture content below 0.1% by weight, it is advantageous to prereact the mixture of polyorganosiloxane (X), water (Y) and catalyst (Z) for a time of from 15 minutes to 120 minutes, preferably 60 minutes, at a temperature of from 50° C. to 180° C., preferably from 90° C. to 170° C., and most preferably from 120° C. to 150° C.

In a preferred embodiment, the total amount of polyorganosiloxane (X) or a mixture of two or more polyorganosiloxanes (X) is mixed with the total amount of catalyst (Z) in step (1) and the reinforcing filler (F) is mixed into the mixture without prereaction. In another preferred embodiment, the total amount of polyorganosiloxane(s) (X) is mixed with the total amount of catalyst (Z) in step (1) and prereacted as described above before addition of the reinforcing filler (F). In another preferred embodiment, a partial amount of the total polyorganosiloxane (X) or a mixture thereof is mixed with the total amount of catalyst (Z) in step (1) and prereacted as described above. The reaction mixture is then cooled to below 120° C., preferably to below 100° C., and the remaining amount of the polyorganosiloxane (X) or mixture thereof is mixed in before the reinforcing filler (F) is added.

The mixing of the polyorganosiloxane (X), the water (Y) and the condensation/equilibration catalyst (Z) in step (1) and optionally the prereaction of this mixture in step (2) are preferably carried out in the same mixing apparatus in which the addition in step (3) and the in-situ treatment in step (4) of the reinforcing filler (F) and the deactivation of the catalyst (Z) in step (5) and optionally the addition of a further polyorganosiloxane (XX) or a mixture of polyorganosiloxanes in step (7) are subsequently carried out.

To achieve complete treatment of the reinforcing filler (F) with sufficient mechanical breaking down of secondary and tertiary structures, and to achieve a sufficiently homogeneous and highly disperse distribution of the treated solid particles with avoidance of gel-like filler/polyorganosiloxane aggregates, the incorporation and treatment of the reinforcing filler (F) is preferably carried out with very high mechanical shear. This can be effected either by stirring the mixture by means of a high-speed toothed disk or by kneading the mixture in a very stiff phase.

Examples of suitable mixing apparatuses are planetary dissolver mixers which have one or more planetary mixing arms and one or more high-speed toothed disks in combination with heatable and coolable mixing vessels. Mixing kneaders with a heatable and coolable trough and two corotating or contrarotating, if appropriate, heatable and coolable kneading blades, internal mixers, continuous mixing extruders and other discontinuous or continuous apparatuses having a comparably intensive mixing action and temperature regulation can also be used. The mixing apparatus preferably allows the interior to be continuously flushed with inert gas, for example nitrogen, and for a vacuum to be applied during particular phases of the mixing process.

Examples of the abovementioned reinforcing filler (F) having a specific surface area (BET) of at least 40 m²/g are pyrogenic silica, precipitated silica, silicon-aluminum mixed oxides and pyrogenic titanium dioxide. Preference is given to pyrogenic and precipitated silicas having a specific surface area (BET) of 50-400 m²/g, particularly preferably 90-300 m²/g. The filler (F) mentioned can have been pretreated, for example with organosilanes, organosilazanes or organosiloxanes, but is preferably hydrophilic. It is possible to use only one type of filler (F) or else a mixture of two or more fillers (F). The filler can be used in amounts of 10-100% by weight, based on the polyorganosiloxane (X), preferably 20-80% by weight, most preferably 30-40% by weight.

The addition of the total amount of the reinforcing filler (F) in step (3) is preferably carried out a little at a time so that the partial amount of filler added is completely incorporated into the mixture without cooling before the next partial amount is added. After addition of the total amount of filler, the polyorganosiloxane/filler/catalyst mixture is mixed at high mixer power for a period of 15 minutes to 10 hours, preferably from 1 hour to 5 hours, more preferably from 2 to 3 hours, at a temperature of from 120° C. to 180° C., preferably from 140° C. to 160° C., in step (4).

The deactivation of the condensation/equilibration catalyst (Z) in step (5) is effected, if (Z) is an acid, by means of a base or, if (Z) is a base, by means of an acid, with the amount of base or acid added in each case being such that complete deactivation of the base or acid by formation of the corresponding salt is ensured. The deactivation of the condensation/equilibration catalyst (Z) is preferably carried out using a deactivating agent (DA) having a comparable base or acid strength. If (Z) is a strong acid, preference is given to using a strong base for deactivation, while if (Z) is a strong base, then preference is given to using a strong acid for deactivation. The same applies analogously in the case of weak acids or bases. This ensures that the salts formed in the deactivation dissociate under the action of moisture to give a reaction in the neutral or only weakly acid or weakly basic range, while the deactivation of a strongly acidic condensation/equilibration catalyst (Z) by means of a weak base would in the case of hydrolysis result in a shift into the distinctly acid range, and deactivation of a strongly basic condensation/equilibration catalyst (Z) by means of a weak acid would in the case of hydrolysis result in a shift into the distinctly basic range. In the case of formation of neutral salts which produce no buffering action, the use of nonvolatile or relatively nonvolatile deactivating agents (DA) even in an added amount which is only insignificantly above or below the amount actually required for neutralization can lead to an undesirably large deviation from the neutral point.

Apart from the particularly preferred use of a deactivating agent (DA) which is sufficiently volatile for subsequent removal of an added excess, a preferred embodiment of the deactivation process (5) comprises addition of a deficiency of a nonvolatile or relatively nonvolatile deactivating agent (DA) in combination with a volatile deactivating agent (DA), so that an overall excess of deactivating agent (DA) is present in the mixture, with the excess consisting exclusively of volatile deactivating agent (DA) which after completion of the deactivation process is removed from the mixture by heat treatment of the mixture while flushing with an inert gas or preferably under reduced pressure.

Particularly preferred relatively nonvolatile deactivating agents (DA) for the particularly preferred catalysts (Z) sodium hydroxide, potassium hydroxide, sodium trimethylsilanolate and potassium trimethylsilanolate are methanesulfonic acid and trimethylsilyl methanesulfonate. Particularly preferred volatile deactivating agents (DA) for the particularly preferred catalysts (Z) sodium hydroxide, potassium hydroxide, sodium trimethylsilanolate and potassium trimethylsilanolate are substances which form a neutral alkali metal halide as reaction product, i.e. hydrogen halides and substituted or unsubstituted organohalosilanes or organohalosiloxanes, most preferably substituted or unsubstituted organohalosilanes having a boiling point at 1013 hPa in the range from 55° C. to 140° C., in each case either alone or in combination. Examples of particularly preferred organohalosilanes are trimethylchlorosilane, vinyldimethylchlorosilane, dimethyldichlorosilane, diethyldichlorosilane, chloromethyldimethylchlorosilane and chloromethylmethyldichlorosilane. Further particularly preferred volatile deactivating agents (DA) are formic acid and acetic acid.

Before addition of the deactivating agent (DA), the mixture is cooled to below 120° C. The amount of deactivating agent (DA) required for neutralization is homogenously mixed in, preferably in a plurality of proportions distributed over the deactivation phase. The amount of deactivating agent (DA) required for the respective suspension (A) is preferably determined experimentally. This can be carried out, for example, by means of alkalimetric or acidimetric measurement of the acid or base content or by means of an acid/base indicator which changes color in the appropriate range.

After the deactivation step, volatile constituents which have been formed by action of the condensation/equilibration catalyst (Z) during the process are preferably removed by heating the suspension (A) in a stream of inert gas and/or under reduced pressure in the temperature range from 80° C. to 180° C., preferably from 120° C. to 150° C.

As the filler content of suspensions of reinforcing fillers in polyorganosiloxanes increases, the suspensions increasingly tend, owing to increased filler/polymer interaction, to display an increase in viscosity on storage, even when the filler has been treated beforehand. It is therefore advantageous for such suspensions which form the basis of ready-to-use polyorganosiloxane preparations to be blended, if they are to be temporarily stored before further processing, with further polyorganosiloxane (XX) or a mixture of polyorganosiloxanes (XX) to reduce this undesirable viscosity increase. In this case, the polyorganosiloxane or polyorganosiloxanes (XX) represent(s) constituents of the formulation of the ready-to-use polyorganosiloxane preparations based on the suspensions (A), i.e. are taken over from the finished composition into the polymer/filler suspension.

Type, properties and amount used of the polyorganosiloxanes (XX) are also determined partly by the crosslinking system selected for the ready-to-use polyorganosiloxane preparations. The polyorganosiloxanes (XX) or mixtures of polyorganosiloxanes (XX) can, both in terms of type and properties, either be identical to the polyorganosiloxanes (X) or be different therefrom, and can be either reactive or unreactive in the respective crosslinking system.

The polyorganosiloxanes (XX) as optional constituent of the suspension (A) are made up of units of the general formula
RₐSiO_{(4-a)/2} (III)
where
the radicals R are identical or different monovalent, Si—C-bonded, substituted or unsubstituted C₁-C₁₈-hydrocarbon radicals, the hydroxyl radical or hydrogen radical, and
a is 0, 1, 2 or 3, on average 1.85-2.4.

Examples of radicals R and of substituted radicals R are identical to those for the formula (I). The polyorganosiloxanes (XX) have a viscosity at 23° C. of from 10 to 500,000 mPa·s, preferably from 100 to 20,000 mPa·s, most preferably from 200 to 10,000 mPa·s. As polyorganosiloxanes (XX), preference is given to using polydiorganosiloxanes of the general formula (IV)
(R¹)ₓ(R²)₃₋ₓSiO[Si(R²)₂O]ₘ [Si(R²)(R¹)O]ₙ Si(R²)₃₋ₓ(R¹)ₓ (IV)
where
the radicals R¹ are identical or different monovalent, SiC-bonded, unsaturated C₁-C₈-alkyl radicals, condensable or hydrolyzable radicals, the radicals R² are identical or different monovalent, SiC-bonded, substituted or unsubstituted saturated C₁-C₁₈-alkyl radicals, substituted or unsubstituted C₁-C₁₈-aryl radicals,
m is 0 or from 1 to 1500, preferably from 0 to 1000, more preferably from 0 to 600,
n is 0 or from 1 to 50,
x is 0 or from 1 to 3.

Other siloxane units in addition to the diorganosiloxane units [Si(R²)₂O] and [Si(R²)(R¹)O] can be present within or along the polysiloxane chains of the general formula (IV). Examples of such other siloxane units are those of the formulae (R²SiO_{3/2}), (R²₃SiO_{1/2}) and SiO_{4/2}, where R² is in each case as defined above. However, the proportion of such siloxane units other than diorganosiloxane units is preferably not more than 10 mol %, in particular not more than 1 mol %, in each case based on the weight of polydiorganosiloxane (XX). Examples of monovalent, SiC-bonded, unsaturated C₁-C₈-alkyl radicals R¹ are alkenyl radicals such as vinyl, allyl, cyclohexenyl, and alkenyloxy, with preference being given to vinyl. Examples of condensable radicals R¹ are hydroxy, hydrogen and halogen, preferably chlorine.

Examples of hydrolyzable radicals R¹ are alkoxy radicals such as the methoxy, ethoxy, n-propoxy, isopropoxy, n-butoxy, and methoxyethoxy radicals; alkenyloxy radicals such as the isopropenyloxy, isobutenyloxy, and 1-ethyl-2-methylvinyloxy; acyloxy radicals such as acetoxy, propionoxy, butyloxy, benzoyloxy, and 2-ethylhexanoyloxy radicals; iminoxy radicals such as the dimethyl ketoxime, methylethyl ketoxime, diethyl ketoxime, cyclopentane oxime, and cyclohexane oxime radicals; amino radicals such as the N-methylamino, N-ethylamino, N-butylamino, N,N-dimethylamino, N,N-diethylamino, and cyclohexylamino; amido radicals such as the N-methylacetamide, N-ethylacetamide, and N-methylbenzamide radicals; and aminoxy radicals such as the N,N-dimethylaminoxy, N,N-diethylaminoxy, and N,N-diphenylaminoxy radicals.

Preferred examples of radicals R² are C₁-C₈-alkyl radicals, most preferably methyl, vinyl and phenyl. x is preferably 0 or 1. As polyorganosiloxane (XX), it is possible to use one type of polydiorganosiloxane (IV) or a mixture of at least two different types of polydiorganosiloxanes (IV).

A preferred embodiment of the flowable, crosslinkable polyorganosiloxane compositions produced by the process of the invention comprises condensation-crosslinking polyorganosiloxane compositions which are produced by mixing
(AA) the suspension (A) produced by the above-described process, with the suspension being able, if desired, to comprise polyorganosiloxane (XX) which can bear condensable or hydrolyzable groups as in the general formula (IV),
(BB) optionally a polyorganosiloxane or a mixture of a plurality of polyorganosiloxanes (XX) which bear(s) condensable or hydrolyzable groups as in the general formula (IV), with the formulation constituent (BB) being obligatory when (AA) comprises no polyorganosiloxane (XX) which bears condensable or hydrolyzable groups as in the general formula (IV),
(CC) optionally one or more crosslinkers selected from among organosilane(s) of general formula
   R²_{4-b} SiR¹_{b} (V),
   where
   the radicals R¹ can be identical or different and can be the same hydrolyzable radicals R¹ as in the general formula (IV), the radicals R² can be identical or different and can be the same radicals R² as in the general formula (IV) and
b is an integer from 2 to 4;
one or more partially hydrolyzed reaction products of organosilanes of the general formula (V), with the formulation constituent (CC) being obligatory when the polyorganosiloxane (XX) present in the formulation constituent (AA) or (BB) is a hydroxy-functional polyorganosiloxane, preferably an α,ω-dihydroxypolyorganosiloxane,
(DD) a crosslinking catalyst effective in the condensation system,
(EE) optionally a polyorganosiloxane or a mixture of a plurality of polyorganosiloxanes (XX) which bear(s) no condensable or hydrolyzable groups as in the general formula (IV), preferably an α,ω-bis(trialkylsiloxy)polyorganosiloxane, with the trialkylsiloxy radical preferably being a trimethylsiloxy or vinyldimethylsiloxy radical,
(FF) optionally one or more nonreinforcing or partially reinforcing fillers,
(GG) optionally one or more polar additives,
(HH) optionally further additives, and
(JJ) optionally water.

Specific examples of organosilanes of the general formula (V) which are suitable as crosslinkers (CC) for the flowable, condensation-crosslinking polyorganosiloxane compositions produced by the process of the invention are methyltrimethoxysilane, chloromethyltrimethoxysilane, ethyltrimethoxysilane, propyltrimethoxysilane, vinyltrimethoxysilane, phenyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-i-propoxysilane, tetra-n-butoxysilane, methyltris(i-propenoxy)silane, vinyltris(i-propenoxy)silane, vinyltris(methoxyethoxy)silane, methyltriacetoxysilane, ethyltriacetoxysilane, vinyltriacetoxysilane, phenyltriacetoxysilane, methyltris(methyl ethyl ketoximo)silane, vinyltris(methyl ethyl ketoximo)silane, bis(N-methylbenzamido)ethoxymethylsilane, tris(cyclohexylamino)methylsilane.

Specific examples of partially hydrolyzed reaction products of organosilanes, as set forth under the general formula (V), which are often described by their SiO₂ content in % by weight, are hexamethoxydisiloxane, hexaethoxydisiloxane, hexa-n-propoxydisiloxane, hexa-n-butoxydisiloxane, octamethoxytrisiloxane, octaethoxytrisiloxane, octa-n-butoxytrisiloxane, decamethoxytetrasiloxane, decaethoxytetrasiloxane, 1,3,5,7-tetramethoxy-1,3,5,7-tetramethylcyclotetrasiloxane, and 1,3,5,7-tetraethoxy-1,3,5,7-tetramethylcyclotetrasiloxane.

The crosslinkers (CC) are used in a proportion, based on the polyorganosiloxane (XX), of from 2 to 50% by weight, preferably from 5 to 20% by weight, more preferably from 1 to 10% by weight, in the polyorganosiloxane preparations of the invention.

Specific examples of compounds which are suitable as crosslinking catalysts (DD) for the flowable, condensation-crosslinking polyorganosiloxane compositions produced by the process of the invention are, inter alia, organic tin compounds such as tin di-2-ethylhexanoate, tin di-2,2-dimethyloctanoate (tin diversatate®), dimethyltin diacetate, dimethyltin di-2-ethylhexanoate, dimethyltin di[2,2-dimethyloctanoate] (dimethyltin diversatate®), dimethyltin dilaurate, dimethyltin hydroxyoleate, dimethyltin distearate, dimethyltin dimaleate, dimethyltin dioleate, di-n-butyltin diacetate, di-n-butyltin di-2-ethylhexanoate, di-n-butyltin di-2,2-dimethyloctanoate (di-n-butyltin diversatate®), di-n-butyltin dilaurate, di-n-butyltin distearate, di-n-butyltin dimaleate, di-n-butyltin di-2-ethylhexylmaleate, di-n-butyltin dibenzylmaleate, di-n-butyltin dioleate, di-n-butyltin di-2,4-pentanedionate, di-n-butyltin dimethoxide, di-n-butyltin chloride butoxide, di-n-octyltin diacetate, di-n-octyltin di-2-ethylhexanoate, di-n-octyltin di-2,2-dimethyloctoate (di-n-octyltin diversatate®), di-n-octyltin dimaleate and di-n-octyltin dilaurate, preferably di-n-butyltin di-2-ethylhexanoate, di-n-butyltin diacetate, di-n-butyltin di-2,2-dimethyloctanoate (di-n-butyltin versatate®), di-n-butyltin dilaurate, di-n-octyltin di-2-ethylhexanoate, di-n-octyltin dimaleate, di-n-octyltin di-2,2-dimethyloctanoate (di-n-octyltin diversatate®) and di-n-octyltin dilaurate; reaction mixtures of organic tin compounds with silanes described under (CC) or partially hydrolyzed products of silanes described under (CC), for example reaction products of tetraethoxysilane or hexaethoxydisiloxane or ethoxyoligosiloxane having an SiO₂ content of about 40% by weight or tetra-n-propoxysilane or tetra-n-butoxysilane with di-n-butyltin diacetate or di-n-octyltin diacetate or di-n-butyltin dilaurate or di-n-octyltin dilaurate, preferably reaction products of tetraethoxysilane with di-n-butyltin diacetate, of hexaethoxydisiloxane with di-n-butyltin diacetate, of tetra-n-propoxysilane with di-n-butyltin diacetate, of tetra-n-butoxysilane with di-n-butyltin diacetate, of tetraethoxysilane with di-n-butyltin dilaurate, of hexaethoxydisiloxane with di-n-butyltin dilaurate, of tetra-n-propoxysilane with di-n-butyltin dilaurate and of tetraethoxysilane with di-n-octyltin diacetate; organic titanium compounds such as tetraethyl titanate, tetra-i-propyl titanate, tetra-n-butyl titanate, tetra-2-ethylhexyl titanate, tetrakis(trimethylsilyl) titanate, bis(diacetylacetonato)di-i-propoxytitanium, bis(2,4-pentanedionato)di-i-propoxytitanium and bis(2,4-pentanedionato)di-n-butoxytitanium; other organic metal compounds such as aluminum alkoxylates, iron 2-ethylhexanoate, iron stearate, cobalt 2-ethylhexanoate, cobalt naphthenate, manganese 2-ethylhexanoate, zinc 2-ethylhexanoate, zinc stearate, zinc naphthenate and lead 2-ethylhexanoate; alkali metal salts of fatty acids, for example lithium oxalate; sodium acetate and potassium acetate; amine compounds such as dibutylamine, hexylamine, octadecylamine; quaternary ammonium salts such as benzyltriethylammonium acetate; dialkylhydroxylamines such as dimethylhydroxylamine and diethylhydroxylamine; aminoalkyl-substituted alkoxysilanes, such as 3-aminopropyltrimethoxysilane, 3-aminopropyltriethoxysilane and N-β-aminoethyl-γ-aminopropyltrimethoxysilane; guanidyl-substituted silanes and siloxanes such as tetramethylguanidylpropyltrimethoxysilane, tetramethylguanidylpropylmethyldimethoxysilane and tetramethyl-guanidylpropyltris(trimethylsiloxy)silane.

The catalysts (DD) can be used individually or in admixture, and in a proportion, based on the polyorganodisiloxane (XX) bearing condensable or hydrolyzable radicals, of from 0.001 to 10% by weight, preferably from 0.01 to 5% by weight.

The nonreinforcing or partially reinforcing fillers (FF) which are suitable for the flowable, condensation-crosslinking polyorganosiloxane compositions produced by the process of the invention preferably have particle sizes in the range from 0.05 μm to 300 μm, particularly preferably from 0.1 μm to 50 μm, and in the case of fibrous fillers from 50 μm to 200 μm.

Specific examples of nonreinforcing or partially reinforcing fillers (FF) are quartz flour, cristobalite flour, diatomaceous earth, mica, aluminum silicates, magnesium-aluminum silicates, calcium metasilicates (wollastonites), zirconium silicates, calcium carbonate, magnesium carbonate, zinc carbonate, aluminum hydroxide, aluminum oxide, iron oxides, titanium oxide, zinc oxide, zirconium oxide, magnesium sulfate, gypsum, annaline, barium sulfate, boron carbide, aluminum nitride, boron nitride, graphite, carbon fibers, metal powders (for example aluminum, copper, silver, gold), glass fibers and hollow glass spheres. The surface of the fillers (FF) can be untreated or treated, with treatment being able to have been carried out by means of, for example, hydrophobicizing organosilicon compounds, preferably alkoxysilanes, organopolysiloxanes or fatty acids.

The fillers (FF) can be used either individually or in combination with one another and/or among one another, with type and amount of the fillers used being selected so that the condensation-crosslinking polyorganosiloxane preparations of the invention have a flowable consistency, i.e. a viscosity of not more than 500,000 mPa·s, preferably not more than 100,000 mPa·s, more preferably not more than 60,000 mPa·s. The total proportion of filler (FF) is preferably from 1 to 80% by weight, particularly preferably from 5 to 50% by weight.

The polar additives (GG) used for the purposes of the present invention undergo, owing to their pronounced polarity, interact in prior art compositions both with sterically accessible SiOH groups still present on the silica surface and with residues of polar filler treatment agents still present in the system or their reaction products, resulting in a more or less strong thickening or thixotropic effect which can go so far as to lead to total loss of the flowability of the originally flowable rubber composition. However, the treatment of the filler by the process of the invention leads to such high shielding of the silica surface that the interaction with such polar additives is too low to be able to cause a significant increase in the viscosity or even loss of flowability.

Examples of such polar additives (GG) are generally known products such as antistatic agents, hydrophilic modifiers, bonding agents, release agents, lubricants, and hydrophobicizing agents.

Examples of additives (GG) suitable as antistatic agents and hydrophilic modifiers are nonionic, amphoteric, anionic and cationic surfactants. Examples of nonionic surfactants are alkyl polyglycol ethers, polyoxyalkylated fatty alcohols and alkylphenols, polyoxyalkylated fatty acids and esters thereof, polyoxyalkylated fatty acid amines and amides, alkyl polyglucosides, N-methylglucamide, sorbitan-fatty acid esters, ethylene oxide (EO)-propylene oxide (PO) block copolymers, ethylenediamine-EO-PO block copolymers, copolymers having (A) diorganosiloxy and (B) alkylene oxide blocks in the chain, of the type ABA, BAB or (AB)ₓ, polyorganosiloxane copolymers having alkylene oxide blocks or polyols in the side chain or at the end of the chain. Examples of amphoteric surfactants are alkylaminocarboxylic acids, betaines such as alkylamidopropylbetaines and alkyldimethylcarboxymethylbetaines and also sulfobetaines such as alkyltrimethylsulfobetaines.

Examples of anionic surfactants are the alkali metal salts, preferably sodium salts, of olefinsulfonates, alkylsulfonates, alkarylsulfonates, alkylsulfates, alkyl ether sulfates, alkaryl ether sulfates, polyglycol ether sulfates, alkylsulfosuccinates, alkylaminosulfosuccinamates, monoalkyl and dialkyl phosphates, phosphoric diesters of polyoxyalkylated fatty alcohols and polyethylene glycol, phosphoric monoesters, diesters and triesters of polyoxyalkylated fatty alcohols, alkylpolyoxyalkylenecarboxylic acids, and also the calcium salts of alkylbenzylsulfonates.

Examples of cationic surfactants are quaternary ammonium compounds such as alkyltrimethylammonium chlorides, alkylbenzyldimethylammonium chlorides, dialkyldimethylammonium chlorides and diacyloxyethylhydroxy-ethylmethylammonium methylsulfates.

As antistatic agents and hydrophilic modifiers for the flowable, condensation-crosslinking polyorganosiloxane compositions produced by the process of the invention, preference is given to anionic surfactants, particularly preferably the sodium salts of monoalkyl and dialkyl phosphates, phosphoric diesters of polyoxyalkylated fatty alcohols and polyethylene glycol and phosphoric monoesters, diesters and triesters of polyoxyalkylated fatty alcohols, for example the sodium salt of the phosphoric ester of lauryl ethoxylate having 2 EO groups and polyethylene glycol. The anionic surfactants have viscosities of from 50 to 2000 mPa·s, preferably from 100 to 1000 mPa·s.

Examples of additives (GG) which are suitable as bonding agents are functional silanes such as N-(2-aminoethyl)-3-aminopropyltrimethoxysilane, N-(2-aminoethyl)-3-aminopropylmethyldimethoxysilane, N-(2-aminoethyl)-3-aminopropyl-triethoxysilane, 3-aminopropyltrimethoxysilane, 3-aminopropyltriethoxysilane, 2-(3,4-epoxycyclohexyl)ethyltrimethoxysilane, 2-(3,4-epoxycyclohexyl)ethyltriethoxysilane, 3-(2,3-epoxypropoxy)propyltrimethoxysilane and 3-(2,3-epoxypropoxy)propyltriethoxysilane, preferably N-(2-aminoethyl)-3-aminopropyltrimethoxysilane, N-(2-aminoethyl)-3-aminopropylmethyldimethoxysilane, N-(2-aminoethyl)-3-aminopropyltriethoxysilane, 3-aminopropyltrimethoxysilane and 3-aminopropyltriethoxysilane.

Examples of additives (GG) which are suitable as release agents, lubricants or hydrophobicizing agents and which bleed out of the vulcanized silicone rubber are aryl-containing polyorganosiloxanes of the general formula (VI)
R³(R⁴₂SiO)ₙSiR⁴₂R³ (VI) where
the radicals R³ are identical or different monovalent, SiC-bonded, substituted or unsubstituted C₁-C₈-alkyl radicals, preferably methyl and vinyl, substituted or unsubstituted C₁-C₈-aryl radicals, preferably phenyl, the radicals R⁴ are identical or different monovalent, SiC-bonded, substituted or unsubstituted C₁-C₈-alkyl radicals, preferably methyl and vinyl, substituted or unsubstituted C₁-C₈-aryl radicals, preferably phenyl, with from 10 to 45 mol % of the radicals R⁴ being aryl radicals, preferably phenyl,
n is from 3 to 50, preferably from 5 to 30.

The aryl-containing polyorganosiloxanes have viscosities in the range from 50 to 500 mPa·s, preferably from 100 to 250 mPa·s.

The polar additives (GG) can be used either individually or in combination with polar additives (GG) of the same type and/or different types, with the amounts added, based on the total polyorganosiloxane preparation, being from 0 to 25% by weight, preferably from 0.1 to 20% by weight, more preferably from 0.1 to 10% by weight, very particularly preferably from 0.1 to 6% by weight.

The further additives (HH) which may optionally be present in the flowable, condensation-crosslinking polyorganosiloxane preparations of the invention can be added to give the systems particular properties, with the proviso that they do not adversely affect the inventive purpose. Such additives (HH) can, for example, serve to control the reactivity of the condensation-crosslinking polyorganosiloxane preparations of the invention, i.e. act as accelerators or inhibitors. Thus, bases in condensation-crosslinking systems usually accelerate the crosslinking reaction, while acids have a retarding effect. The reactivity can also be reduced by addition of silanol-containing compounds, preferably α,ω-dihydroxypolydiorganosiloxanes of the general formula HO(R³₂SiO)ₙH, where n is preferably 3-200 and the radicals R³ are identical or different monovalent, Si—C-bonded, substituted or unsubstituted C₁-C₁₈-hydrocarbon radicals, preferably having a viscosity at 23° C. of from 10 to 1000 mPa·s, more preferably from 20 to 500 mPa·s, in a proportion of from 0.1 to 10% by weight, preferably from 0.2 to 3% by weight. Furthermore, the additives (HH) can improve particular properties, for example heat resistance or resistance to combustion, by addition of, for example, cerium oxide, zinc carbonate, manganese carbonate, benzotriazole or platinum compounds, or in the case of soluble dyes or insoluble pigments can serve to impart color. The examples of additives (HH) given here are only illustrative examples and are not to be interpreted as a restriction of the polyorganosiloxane preparations of the invention.

A particular amount of water is necessary for the condensation crosslinking of polyorganosiloxane compositions. The amount of added water (JJ) is preferably from 0 to 2% by weight, based on the polyorganosiloxane (XX) having condensable or hydrolyzable radicals, more preferably from 0 to 1% by weight, with no addition of water being necessary when a sufficient amount of water is introduced into the system via other constituents of the condensation-crosslinking polyorganosiloxane composition.

The condensation-crosslinking polyorganosiloxane preparations of the invention can be formulated either as single-component, two-component or multicomponent systems.

To obtain single-component systems, all formulation constituents are mixed under water-free conditions. The compositions obtained in this way vulcanize under the action of atmospheric moisture or by addition of water, usually at room temperature, if desired, also at elevated temperatures up to 100° C.

To obtain two-component or multicomponent systems, the formulation constituents are divided up so as to give two or more components which are mixed with one another in order to carry out vulcanization, with one of the components comprising the catalyst (DD) or a plurality of catalysts (DD) and, if appropriate, also the crosslinker (CC) or a plurality of crosslinkers (CC). In a preferred embodiment, two components are formulated so that one of the two components comprises both the crosslinker (CC) or a plurality of crosslinkers (CC) and the catalyst (DD) or a plurality of catalysts (DD).

A further preferred embodiment of the flowable, crosslinkable polyorganosiloxane compositions produced by the process of the invention comprises addition-crosslinking polyorganosiloxane compositions which are produced by mixing:
(AAA) the suspension (A) produced by the above-described process, with the suspension being able, if desired, to comprise polyorganosiloxane (X) which can bear identical or different monovalent, SiC-bonded, unsaturated C₁-C₈-alkyl radicals as in the general formula (IV), but preferably vinyl radicals, or being able, if desired, to comprise polyorganosiloxane (XX) which may bear identical or different monovalent, SiC-bonded, unsaturated C₁-C₈-alkyl radicals as in the general formula (IV), but preferably vinyl radicals, or hydrogen radicals,
(BBB) optionally a polyorganosiloxane (XX) or a mixture of a plurality of polyorganosiloxanes (XX) which bear identical or different monovalent, SiC-bonded, unsaturated C₁-C₈-alkyl radicals as in the general formula (IV), preferably vinyl radicals, with the formulation constituent (BBB) being obligatory when (AAA) contains no polyorganosiloxane (X) which bears identical or different monovalent, SiC-bonded, unsaturated C₁-C₈-alkyl radicals as in the general formula (IV), preferably vinyl radicals, or contains no polyorganosiloxane (XX) which bears identical or different monovalent, SiC-bonded, unsaturated C₁-C₈-alkyl radicals as in the general formula (IV), but preferably vinyl radicals,
(CCC) optionally one or more crosslinkers selected from among organohydrogenpolysiloxanes of the general formula
   R′_{b}H_{c}SiO_{(4-b-c)/4} (VII),
   where
   the radicals R′ are, in each case for themselves independently of one another, radicals R² as in the general formula (IV)
   b is from 0.6 to 2.3 and
   c is from 0.005 to 1.3
   with the proviso that the sum (b+c) is from 0.8 to 2.7 and the organohydrogenpolysiloxane of the general formula (VII) has at least two Si-bonded hydrogen radicals in each molecule, with the formulation constituent (CCC) being obligatory when the polyorganosiloxane (XX) present in the formulation constituent (AAA) is not an organohydrogenpolysiloxane, and the molar ratio of the Si—H groups in the crosslinker (CCC) and optionally in the polyorganosiloxane (XX) as constituent of the suspension (A) to the alkenyl groups in the formulation constituents (AAA) and optionally (BBB) is from 0.3 to 10, preferably from 0.5 to 5,
(DDD) a crosslinking catalyst which is effective in the addition system,
(EEE) optionally a polyorganosiloxane or a mixture of a plurality of polyorganosiloxanes (XX) which bear no condensable or hydrolyzable groups as in the general formula (IV), preferably α,ω-bis(trialkylsiloxy)polyorganosiloxanes, more preferably α,ω-bis(trimethylsiloxy)polydimethylsiloxanes,
(FFF) optionally one or more nonreinforcing or partially reinforcing fillers as described above under (FF),
(GGG) optionally one or more polar additives as described in detail above under (GG) and
(HHH) optionally further additives.

The crosslinkers (CCC) can be linear, branched or cyclic organohydrogenpolysiloxanes described by the general formulae (VIII), (IX) and (X)
H_{y}(R″)_{3-y}SiO[Si(R″)₂O]ₘ [SiH(R″)O]ₙ Si(R″)_{3-y}H_{y} (VIII)
[Si(R″)₂O]ₚ [SiH(R″)O]_{q} (IX)
[(R″)₃₋ᵣHᵣSiO]_{z}SiHₛ(R″)_{4-s-z} (X)
where
the radicals R″ are identical or different monovalent, SiC-bonded, substituted or unsubstituted, saturated or unsaturated C₁-C₈-alkyl radicals, preferably methyl and vinyl, substituted or unsubstituted C₁-C₈-aryl radicals, preferably phenyl,
m is 0 or from 1 to 300, preferably from 0 to 200, more preferably from 0 to 150,
n is 0 or from 1 to 100, preferably from 0 to 60,
p is 0 or from 1 to 6, preferably from 0 to 4,
q is from 2 to 8,
r is from 1 to 2,
s is 0 or 1,
y is 0 or from 1 to 2, preferably from 0 to 1, and
z is from 2 to 4, preferably from 3 to 4.

Specific examples of crosslinkers (CCC) are α,ω-bis(dimethylhydridosiloxy)polydimethylsiloxanes; polymethyl-H-siloxanes or dimethylsiloxane-methyl-H-siloxane copolymers having dimethylhydridosiloxy or trimethylsiloxy groups at the ends of the chains; cyclic polymethyl-H-siloxanes or cyclic dimethylsiloxane-methyl-H-siloxane copolymers, tetrakis(dimethylhydridosiloxy)silane, tris(dimethylhydridosiloxy)methylsilane and tris(dimethylhydridosiloxy)silane. The crosslinkers (CCC) preferably have a viscosity of up to 2000 mPa·s at 23° C.

The catalysts (DDD) which are suitable for the flowable, addition-crosslinking polyorganosiloxane compositions produced by the process of the invention are preferably metals of transition group VIII of the Periodic Table, e.g. platinum, rhodium or palladium, and their compounds, preferably platinum and its compounds. Specific examples of catalysts (DDD) are platinum black, hexachloroplatinic acid and platinum complexes with olefins, aldehydes, vinylsiloxanes or acetylene carbinols.

The catalysts (DDD) can be used individually or in admixture, and in a proportion, based on the total amount of polyorganosiloxane (X) and/or polyorganosiloxane (XX) having alkenyl groups, of from 0.1 to 2000 ppm, preferably from 1 to 500 ppm, more preferably from 5 to 100 ppm.

Among the optionally one or more polar additives (GGG) as described in detail above under (GG), antistatic agents and hydrophilic modifiers for the flowable, addition-crosslinking polyorganosiloxane compositions produced by the process of the invention are preferably nonionic surfactants, more preferably
a) ethylene oxide (EO)/propylene oxide (PO) block copolymers of the general formula (XI)
   HO(C₂H₄O)ₓ(C₃H₆O)_{y}H (XI),
   where
   x is 0.05-0.6 y, preferably 0.2-0.4 y,
   x+y is 40-60, preferably 45-55,
b) copolymers of (A) diorganosiloxy and (B) EO and/or PO blocks in the chain of the BAB type of the general formula (XII)
   X(CₙH₂ₙO)ₓ(CH₂)_{y}—(CH₂)_{y}(OCₙH₂ₙ)ₓX (XII),
   where
   R² has the same meaning as in formula (II), but is preferably methyl,
   X is hydroxy or alkoxy, preferably hydroxy, methoxy, ethoxy, propoxy,
   n is 2 or 3,
   m is from 1 to 50, preferably from 10 to 20,
   x is from 1 to 20, preferably from 5 to 15, and
   y is 1, 2 or 3, preferably 3,
c) polyorganosiloxanes having alkylene oxide blocks or polyols in the side chain or at the end of the chain and having the formula (XIII)
   R⁵₃SiO(R⁵₂SiO)ₓ(R⁵YSiO)_{y}OSiR⁵₃ (XIII),
   where
   the radicals R⁵ are identical or different monovalent, SiC-bonded, saturated or unsaturated C₁-C₈-alkyl radicals, preferably methyl and vinyl, or hydrogen,
   x is 0 or from 1 to 250, preferably from 10 to 200,
   y is from 1 to 50, preferably from 10 to 40, and
   Y is —CₙH₂ₙ(OCH₂CH₂)ₚ(OCH₂CH₂CH₂)_{q}Q, where
   Q is OH or a C₁-C₆-alkoxy radical, preferably OH, methoxy, ethoxy, propoxy,
   n is 0-6, preferably 2 or 3, particularly preferably 3,
   p is ≧1, preferably 2-8, particularly preferably 3-6, and
   q is ≧0, preferably 0-1, particularly preferably 0.

The nonionic surfactants have viscosities of from 50 to 2000 mPa·s, preferably from 100 to 1000 mPa·s.

Examples of polar additives (GGG) as described in detail above under (GG) which are suitable as bonding agents for the flowable, addition-crosslinking polyorganosiloxane compositions produced by the process of the invention are functional silanes such as vinyltrimethoxysilane, vinyltriethoxysilane, vinyltris(2-methoxyethoxy)silane, allyltrimethoxysilane, 2-(3,4-epoxycyclohexyl)ethyltrimethoxysilane, 2-(3,4-epoxycyclohexyl)ethyltriethoxysilane, 3-(2,3-epoxypropoxy)propyltrimethoxysilane, 3-(2,3-epoxypropoxy)propyltriethoxysilane, 3-methacryloxypropyltrimethoxysilane, 3-methacryloxypropyltriethoxysilane, preferably3-(2,3-epoxypropoxy)propyltrimethoxysilane and 3-methacryloxypropyltrimethoxysilane.

Examples of additives (GGG) which are suitable as release agents, lubricants or hydrophobicizing agents and which bleed out of the vulcanized silicone rubber are aryl-containing polyorganosiloxanes of the general formula (VI)
R³(R⁴₂SiO)ₙSiR⁴₂R³ (VI)
where
the radicals R³ are identical or different monovalent, SiC-bonded, substituted or unsubstituted C₁-C₈-alkyl radicals, preferably methyl and vinyl, substituted or unsubstituted C₁-C₈-aryl radicals, preferably phenyl,
the radicals R⁴ are identical or different monovalent, SiC-bonded, substituted or unsubstituted C₁-C₈-alkyl radicals, preferably methyl and vinyl, substituted or unsubstituted C₁-C₈-aryl radicals, preferably phenyl, with from 10 to 45 mol % of the radicals R⁴ being aryl radicals, preferably phenyl, and
n is from 3 to 50, preferably from 5 to 30.

The aryl-containing polyorganosiloxanes have viscosities in the range from 50 to 500 mPa·s, preferably from 100 to 250 mPa·s.

The polar additives (GGG) can be used either individually or in combination with polar additives (GGG) of the same type or different type, with the amounts added, based on the total polyorganosiloxane preparation, being from 0 to 10% by weight, preferably from 0 to 5% by weight.

The further additives (HHH) which may optionally be present in the flowable, addition-crosslinking polyorganosiloxane preparations of the invention can be added to give the systems particular properties, with the proviso that they do not adversely affect the inventive purpose.

Such additives (HHH) can, for example, be catalyst inhibitors (DDD) which are suitable for controlling the reactivity of the addition-crosslinking polyorganosiloxane preparations of the invention. Preferred examples of such inhibitors are siloxanes having unsaturated groups, e.g. 1,3-divinyl-1,1,3,3-tetramethyldisiloxane, 1,3,5,7-tetravinyl-1,3,5,7-tetramethylcyclotetrasiloxane, 1,3,5,7-tetracyclohexenyl-1,3,5,7-tetramethylcyclotetrasiloxane, polyvinylmethylsiloxane or dimethylsiloxane-vinylmethylsiloxane copolymers and also acetylene alcohols such as 1-ethynyl-1-cyclohexanol and 2-methyl-3-butyn-2-ol, 3-methyl-1-butyn-3-ol, 3,5-dimethyl-1-hexyn-3-ol, 3-phenyl-1-butyn-3-ol; triazole compounds such as benzotriazole.

The amount of such inhibitors which is to be added depends on the storage, processing and vulcanization conditions and can be from 1 ppm to 50,000 ppm, preferably from 10 ppm to 10,000 ppm, based on the total amount of polyorganosiloxane (X) and/or polyorganosiloxane (XX) bearing alkenyl groups. Furthermore, the additives (HHH) can improve particular properties, for example the heat resistance or the resistance to combustion, by addition of, for example, cerium oxide, antimony oxide, zinc carbonate, manganese carbonate, benzotriazole or platinum compounds, or in the case of soluble dyes or insoluble pigments can serve to impart color.

The examples of additives (HHH) mentioned here are only illustrative examples and are not to be interpreted as a restriction of the polyorganosiloxane preparations of the invention.

The flowable, addition-crosslinking polyorganosiloxane preparations of the invention can be formulated either as single-component, two-component or multicomponent systems. To obtain single-component systems, all formulation constituents are mixed. Addition of a sufficiently effective inhibitor for the catalyst (DDD), preferably acetylene alcohols such as 1-ethynyl-1-cyclohexanol and 2-methyl-3-butyn-2-ol, makes storage times of up to one year possible. Vulcanization is then carried out at elevated temperatures of from 150° C. to 200° C.

To obtain two-component or multicomponent systems, the formulation constituents are divided up so as to give two or more components which are mixed with one another to effect vulcanization, with one of the components comprising the catalyst (DDD) or a plurality of catalysts (DDD) and another comprising the crosslinker (CCC) or a plurality of crosslinkers (CCC).

The flowable, condensation- or addition-crosslinking organopolysiloxane preparations based on the inventive suspensions comprising polyorganosiloxanes and reinforcing fillers are in principle suitable for all applications in which flowable silicone rubber compositions which can be vulcanized at room temperature or elevated temperatures and give an improved vulcanizate strength can advantageously be used, if appropriate with addition of particular additives, for example for the encapsulation of electrical or electronic components, for gaskets and seals, for the production of moldings including printing pads and for making molds of originals, including dental moldings.

### EXAMPLES

The following examples serve to illustrate the process of the invention for producing suspensions of reinforcing fillers in polyorganosiloxanes, the use of these suspensions for producing flowable condensation- and addition-crosslinking polyorganosiloxane preparations and also the viscosity tolerance of these preparations to the addition of polar additives.

These examples in no way restrict or limit the total range of applications of the preparations of the invention.

All parts are parts by weight.

The in situ treatment of the filler and production of the polyorganosiloxane/filler dispersions was carried out in a 15 l mixing kneader having a heatable and coolable trough and two contrarotating kneading blades at atmospheric pressure under a stream of inert gas (N₂; about 200 l/h) using a cooling trap for the removal of volatile substances in the inert gas stream. The mixing constituents were selected so that after addition of all of the reinforcing filler a very stiff but still fully homogeneous phase was obtained so as to achieve the highest possible shearing of the polyorganosiloxane/filler mixture. The finished polyorganosiloxane/filler dispersions were passed through a two-roll mill and additionally strained through a 100 μm screen.

The ready-to-use polyorganosiloxane preparations were produced in a 5 l planetary dissolver with a heatable and coolable vessel and a facility for evacuation.

The measurement of the viscosity of the polymer/filler dispersions was carried out by means of a dynamic cone-and-plate viscometer model MCR 300 from Physica in accordance with the standard DIN EN ISO 3219 under the following conditions:

| | |
|---|---|
| Temperature: | 25° C. |
| Measurement method: | rotation measurement |
| Cone/plate geometry: | diameter 25 mm; cone angle 2° |
| Measurement type: | shear-rate-controlled |
| Shear rate range: | 0.1-1 s⁻¹ |
| Measurement time: | 2 min |
| Number of measured values: | 30 (logarithmic distribution: 10 s for |
| | the 1st value and 1 s for the last value) |
| Evaluation: | viscosity reported in mPa · s as |
| | interpolated value at a shear rate D of |
| | 0.89 s⁻¹. |

The measurement of the viscosity of the ready-to-use polyorganosiloxane preparations and their processing time was carried out by means of a digital viscometer model RVTDV-I from Brookfield with appropriate spindle and at 2.5 revolutions/min at 23° C./50% relative atmospheric humidity in accordance with the standard EN ISO 2555.

The processing time was defined as the period of time between mixing of the two components A and B and the point in time at which the catalyzed mixture reached a viscosity of 60,000 mPa·s.

In the case of the condensation-crosslinking systems, the mechanical properties were measured on cast vulcanizate sheets which had a thickness of 2 mm and had been stored for 4 days under standard conditions (23° C./50% relative atmospheric humidity) after removal from the mold, and in the case of the addition-crosslinking systems were measured on vulcanizate sheets which had a thickness of 2 mm and had been produced at 100° C. for 10 minutes in a heatable hydraulic press at a pressing pressure of 200 bar and had been stored for 1 hour under standard conditions (23° C./50% relative atmospheric humidity) after removal from the mold. The measurements of:
the Shore A hardness were carried out in accordance with DIN standard EN ISO 868 (DIN 53505)
the tensile strength in N/mm² and the elongation at break in % were carried out in accordance with DIN standard 53504 S 3A
the tear strengths in N/mm were carried out in accordance with DIN standard 53507 (ISO 34-1)—strip specimen (trouser test piece).

### Example 1

3500 g of an α,ω-bis(vinyldimethylsiloxy)polydimethylsiloxane having a viscosity of 1000 mPa·s and a residual SiOH content of 200 ppm were mixed with 30 g of a 50% aqueous solution of KOH in the kneader under a stream of inert gas. Without heating or cooling, a total of 2450 g of an untreated pyrogenic silica having a BET surface area of 140 m²/g were incorporated a little at a time over a period of 60 minutes. After the addition of the filler was complete, the mixture was kneaded while heating for three hours, with the composition reaching a temperature of 150° C. After a cooling phase of 20 minutes (temperature of the mixture: 100° C.), 10 g of methanesulfonic acid (98% pure) and then 40 g of a mixture of 20 g of vinyldimethylchlorosilane and 20 g of an α,ω-bis(trimethylsiloxy)polydimethylsiloxane having a viscosity of 100 mPa·s in four equal portions were mixed in. After kneading for 1 hour without cooling, the mixture was heated at 150° C. in a stream of inert gas for two hours, and then cooled to 90° C. Finally, firstly 300 g of an α,ω-dihydroxypolydimethylsiloxane having a viscosity of 12,000 mPa·s and an OH content of 900 ppm and then 850 g of an α,ω-dihydroxypolydimethylsiloxane having a viscosity of 6000 mPa·s and an OH content of 1100 ppm were mixed in. The polymer/filler dispersion (1) had a viscosity of 180,000 mPa·s. A condensation-crosslinking polyorganosiloxane preparation (1 A) was prepared on the basis of the polymer/filler dispersion (1) by mixing of:

| | |
|---|---|
| 2.20 kg | of polymer/filler dispersion (1), |
| 0.80 kg | of quartz flour having a mean particle size of 3 μm, |
| 0.15 kg | of α,ω-dihydroxypolydimethylsiloxane having a viscosity |
| | of 500 mPa · s and an OH content of 2800 ppm, |
| 0.35 kg | of α,ω-dihydroxypolydimethylsiloxane having a viscosity |
| | of 12,000 mPa · s and an OH content of 900 ppm, |
| 0.50 kg | of α,ω-dihydroxypolydimethylsiloxane having a viscosity |
| | of 20,000 mPa · s and an OH content of 750 ppm and |
| 0.40 kg | of α,ω-bis(trimethylsiloxy)polydimethylsiloxane having a |
| | viscosity of 100 mPa · s and a residual OH content of 600 ppm. |

The polyorganosiloxane preparation (1 A) had a viscosity of 30,000 mPa·s.

100 parts of the polyorganosiloxane preparation (1 A) were mixed with 5 parts of a hardener preparation (1 B) consisting of

2 parts of tetra-n-propoxysilane,

1 part of di-n-butyltin dineodecanoate and

2 parts of α,ω-bis(trimethylsiloxy)polydimethylsiloxane having a viscosity of 100 mPa·s.

The catalyzed mixture had a viscosity of 25,000 mPa·s and a processing time of 40 minutes. The mechanical properties are shown in Table 1.

### Example 2 (Comparative Example)

2450 g of an α,ω-bis(vinyldimethylsiloxy)polydimethylsiloxane having a viscosity of 1000 mPa·s and a residual SiOH content of 200 ppm were mixed with a total of 2450 g of a pyrogenic silica which had been treated with hexamethyldisilazane and had a BET surface area of 140 m²/g and was added a little at a time over a period of 45 minutes in the kneader under a stream of inert gas and without heating or cooling. After the addition of the filler was complete, the mixture was kneaded for one hour without heating or cooling, with the composition reaching a temperature of 140° C. The mixture was then heated at 150° C. in a stream of inert gas for two hours and was subsequently cooled to 90° C. Finally, firstly 300 g of an α,ω-dihydroxypolydimethylsiloxane having a viscosity of 12,000 mPa·s and an OH content of 900 ppm and then 850 g of an α,ω-dihydroxypolydimethylsiloxane having a viscosity of 6000 mPa·s and an OH content of 1100 ppm and also a further 1050 g of the α,ω-bis(vinyldimethylsiloxy)polydimethylsiloxane having a viscosity of 1000 mPa·s and a residual SiOH content of 200 ppm were mixed in. The polymer/filler dispersion (2) had a viscosity of 600,000 mPa·s.

A condensation-crosslinking polyorganosiloxane preparation (2 A) having a composition identical to that of the preparation (1 A) was produced on the basis of the polymer/filler dispersion (2), and this had a viscosity of 35 000 mPa·s.

100 parts of the polyorganosiloxane preparation (2 A) were mixed with 5 parts of hardener preparation (2 B) which was identical to hardener preparation (1 B).

The catalyzed mixture had a viscosity of 22,000 mPa·s and a processing time of 100 minutes. The mechanical properties are shown in Table 1.

### Example 3 (Comparative Example)

3500 g of an α,ω-bis(vinyldimethylsiloxy)polydimethylsiloxane having a viscosity of 1000 mPa·s and a residual SiOH content of 200 ppm were mixed with 45 g of water and 370 g of hexamethyldisilazane in the kneader under a stream of inert gas. Without heating or cooling, a total of 2450 g of an untreated pyrogenic silica having a BET surface area of 140 m²/g were incorporated a little at a time over a period of 30 minutes. After the addition of the filler was complete, the mixture was kneaded for one hour without heating or cooling, with the composition reaching a temperature of 100° C. The mixture was subsequently heated at 150° C. in a stream of inert gas for two hours, and then cooled to 90° C. Finally, first 300 g of an α,ω-dihydroxypolydimethylsiloxane having a viscosity of 12,000 mPa·s and an OH content of 900 ppm and then 850 g of an α,ω-dihydroxypolydimethylsiloxane having a viscosity of 6000 mPa·s and an OH content of 1100 ppm were mixed in. The polymer/filler dispersion (3) had a viscosity of 6,500,000 mPa·s.

A condensation-crosslinking polyorganosiloxane preparation (3 A) having a composition identical to that of preparation (1 A) was prepared on the basis of the polymer/filler dispersion (3), and this had a viscosity of 50,000 mPa·s.

100 parts of the polyorganosiloxane preparation (3 A) were mixed with 5 parts of hardener preparation (3 B) which was identical to hardener preparation (1 B). The catalyzed mixture had a viscosity of 45,000 mPa·s and a processing time of 12 minutes. The mechanical properties are shown in Table 1.

TABLE 1

| | Dynamic viscosity | | | | | | |
|---|---|---|---|---|---|---|---|
| | of polymer/filler | Dynamic | Dynamic viscosity | Shore A | Tensile | | Tear strength |
| | dispersion | viscosity of | of A + B (100:5) | Hardness | strength | Elongation | (strip specimen) |
| Example | [mPa · s] | A [mPa · s] | [mPa · s] | [points] | [N/mm²] | at break | [N/mm] |
| 1 | 180,000 | 30,000 | 25,000 | 23 | 3.0 | 310 | 6.0 |
| 2 | 600,000 | 35,000 | 22,000 | 20 | 3.5 | 310 | 4.6 |
| 3 | 6,500,000 | 50,000 | 45,000 | 24 | 3.6 | 310 | 6.6 |

* comparative example

The polyorganosiloxane preparations 1 A, 2 A and 3 A were each admixed with a polar additive in an effective concentration. Ten minutes after addition of the additive, the viscosity was measured (Table 1a):

TABLE 1a

| | Viscosity [mPa · s] | | |
|---|---|---|---|
| | Example | Comparative Example | |
| | 1A | 2A | 3A |
| Without addition of additive | 30,000 | 35,000 | 50,000 |
| 2% of additive 1* (antistatic agent) | 28,000 | 1) | 1) |
| 1% of additive 2** (bonding agent) | 40,000 | 1) | 1) |

*Sodium salt of the phosphoric ester of lauryl ethoxylate having 2 EO groups and polyethylene glycol
**N-(2-aminoethyl)-3-aminopropyltriethoxysilane
1) non-sag/not measurable

### Example 4

1750 g of an α,ω-bis(vinyldimethylsiloxy)polydimethylsiloxane having a viscosity of 1000 mPa·s and a residual SiOH content of 10 ppm were mixed with 30 g of a 50% aqueous solution of KOH in the kneader under a stream of inert gas. The mixture was kneaded at 150° C. for one hour and subsequently cooled while kneading to 100° C. 1750 g of an α,ω-bis(vinyldimethylsiloxy)polydimethylsiloxane having a viscosity of 1000 mPa·s and a residual SiOH content of 200 ppm were then mixed in. Without heating or cooling, a total of 2450 g of an untreated pyrogenic silica having a BET surface area of 140 m²/g were then incorporated a little at a time over a period of 60 minutes. After the addition of the filler was complete, the mixture was kneaded while heating for three hours, with the composition reaching a temperature of 150° C. After a cooling phase until a mixing temperature of 120° C. had been reached, 10 g of methanesulfonic acid and then 56 g of a mixture of 28 g of vinyldimethylchlorosilane and 28 g of an α,ω-bis(trimethylsiloxy)polydimethyl-siloxane having a viscosity of 100 mPa·s in four equal portions were mixed in. After kneading for one hour without cooling, the mixture was heated at 150° C. in a stream of inert gas for two hours, and then cooled to 120° C. Finally, 2600 g of an α,ω-dihydropolydimethylsiloxane having a viscosity of 1000 mPa·s and an H content of 120 ppm were mixed in. The polymer/filler dispersion (4) had a viscosity of 52,000 mPa·s.

An addition-crosslinking polyorganosiloxane preparation (4 A) was produced on the basis of the polymer/filler dispersion (4) by mixing of

| | |
|---|---|
| 3.60 kg | of polymer/filler dispersion (4), |
| 0.08 kg | of quartz flour having a mean particle size of 3 μm, |
| 0.09 kg | of α,ω-bis(vinyldimethyl)polydimethylsiloxane having a |
| | viscosity of 1000 mPa · s and a vinyl content of 3200 ppm, |
| 0.03 kg | of α,ω-bis(vinyldimethyl)polydimethylsiloxane having a |
| | viscosity of 20,000 mPa · s and a vinyl content of 1200 ppm, |
| 0.64 kg | of α,ω-dihydropolydimethylsiloxane having a viscosity of |
| | 1000 mPa · s and an H content of 120 ppm and |
| 0.06 kg | of α,ω-bis(trimethylsiloxy)polydimethyl(methyl-H-)-siloxane |
| | having a viscosity of 180 mPa · s and an H content of 1800 ppm. |

The polyorganosiloxane preparation (4 A) had a viscosity of 23,000 mPa·s.

In addition, an addition-crosslinking polyorganosiloxane preparation (4 B) was produced by mixing of

| | |
|---|---|
| 0.225 kg | of α,ω-bis(vinyldimethyl)polydimethylsiloxane having a |
| | viscosity of 200 mPa · s and a vinyl content of 7400 ppm, |
| 0.175 kg | of α,ω-bis(vinyldimethyl)polydimethylsiloxane having a |
| | viscosity of 1000 mPa · s and a vinyl content of 3200 ppm, |
| 0.067 kg | of α,ω-bis(vinyldimethyl)polydimethylsiloxane having a |
| | viscosity of 20,000 mPa · s and a vinyl content of 1200 ppm, |
| 0.020 kg | of pyrogenic silica which has been pretreated with |
| | hexamethyldisilazane and has a BET surface area of 140 m²/g, |
| 0.006 kg | of platinum-1,3-divinyl-1,1,3,3-tetramethyldisiloxane complex |
| | (as described in U.S. Pat. No. 3,775,452, column 2, line 14- |
| | column 4, line 39) in α,ω-bis(vinyldimethyl)poly- |
| | dimethylsiloxane having a viscosity of 1000 mPa · s |
| | (platinum content: 10,000 ppm) and |
| 0.007 kg | of 1,3-divinyl-1,1,3,3-tetramethyldisiloxane. |

The polyorganosiloxane preparation (4 B) had a viscosity of 900 mPA·s.

450 parts of the polyorganosiloxane preparation (4 A) were mixed with 50 parts of the polyorganosiloxane preparation (4 B). The catalyzed mixture had a viscosity of 15,000 mPa·s and a processing time of 30 minutes. The mechanical properties are shown in Table 2.

### Example 5

1750 g of an α,ω-bis(vinyldimethylsiloxy)polydimethylsiloxane having a viscosity of 1000 mPa·s and a residual SiOH content of 10 ppm were mixed with 60 g of a 65% aqueous solution of KOH in the kneader under a stream of inert gas. The mixture was kneaded at 150° C. for one hour and subsequently cooled while kneading to 100° C. 1750 g of an α,ω-bis(vinyldimethylsiloxy)polydimethyl-siloxane having a viscosity of 1000 mPa·s and a residual SiOH content of 200 ppm were then mixed in. Without heating or cooling, a total of 2450 g of an untreated pyrogenic silica having a BET surface area of 140 m²/g were then incorporated a little at a time over a period of 60 minutes. After the addition of the filler was complete, the mixture was kneaded while heating for three hours, with the composition reaching a temperature of 150° C. After a cooling phase until a mixing temperature of 120° C. had been reached, 50 g of formic acid were mixed in in two equal portions. After kneading for one hour without cooling, the mixture was heated at 150° C. in a stream of inert gas for two hours, and then cooled to 120° C. Finally, 2600 g of an α,ω-dihydropolydimethylsiloxane having a viscosity of 1000 mPa·s and an H content of 120 ppm were mixed in. The polymer/filler dispersion (5) had a viscosity of 41,000 mPa·s.

An addition-crosslinking polyorganosiloxane preparation (5 A) having a composition identical to that of preparation (4 A) was produced on the basis of the polymer/filler dispersion (5), and this had a viscosity of 19,500 mPa·s. 450 parts of the polyorganosiloxane preparation (5 A) were mixed with 50 parts of the polyorganosiloxane preparation (5 B) which was identical to the polyorganosiloxane preparation (4 B).

The catalyzed mixture had a viscosity of 14,000 mPa·s and a processing time of 35 minutes. The mechanical properties are shown in Table 2.

### Example 6 (Comparative Example)

A mixture of 1750 g of an α,ω-bis(vinyldimethyl-siloxy)polydimethyl-siloxane having a viscosity of 1000 mPa·s and a residual SiOH content of 10 ppm and 1750 g of an α,ω-bis(vinyldimethylsiloxy)poly-dimethylsiloxane having a viscosity von 1000 mPa·s and a residual SiOH content of 200 ppm were mixed with a total of 2450 g of a pyrogenic silica which had been treated with hexamethyldisilazane and had a BET surface area of 140 m²/g and was added a little at a time over a period of 15 minutes in the kneader under a stream of inert gas and without heating or cooling. After the addition of the filler was complete, the mixture was kneaded for one hour without heating or cooling, with the composition reaching a temperature of 82° C. The mixture was then heated at 150° C. in a stream of inert gas for three hours and was subsequently cooled to 90° C. Finally, 2600 g of an α,ω-dihydroxypolydimethylsiloxane having a viscosity of 1000 mPa·s and an H content of 120 ppm were mixed in. The polymer/filler dispersion (6) had a viscosity of 134,000 mPa·s.

An addition-crosslinking polyorganosiloxane preparation (6 A) having a composition identical to that of preparation (4 A) was produced on the basis of the polymer/filler dispersion (6), and this had a viscosity of 38,000 mPa·s.

450 parts of the polyorganosiloxane preparation (6 A) were mixed with 50 parts of the polyorganosiloxane preparation (6 B) which was identical to the polyorganosiloxane preparation (4 B).

The catalyzed mixture had a viscosity of 26,000 mPa·s and a processing time of 67 minutes. The mechanical properties are shown in Table 2.

### Example 7 (Comparative Example)

A mixture of 1750 g of an α,ω-bis(vinyldimethylsiloxy)poly-dimethylsiloxane having a viscosity of 1000 mPa·s and a residual SiOH content of 10 ppm and 1750 g of an α,ω-bis(vinyldimethylsiloxy)polydimethylsiloxane having a viscosity of 1000 mPa·s and a residual SiOH content of 200 ppm were mixed with 110 g of water and 370 g of hexamethyldisilazane in the kneader under a stream of inert gas. Without heating or cooling, a total of 2450 g of an untreated pyrogenic silica having a BET surface area of 140 m²/g were incorporated a little at a time over a period of 15 minutes. After the addition of the filler was complete, the mixture was kneaded for one hour without heating or cooling, with the composition reaching a temperature of 70° C. The mixture was subsequently heated at 150° C. in a stream of inert gas for three hours, and was then cooled to 90° C. Finally, 2600 g of an α,ω-dihydropolydimethylsiloxane having a viscosity of 1000 mPa·s and an H content of 120 ppm were mixed in. The polymer/filler dispersion (7) had a viscosity of 58,000 mPa·s.

An addition-crosslinking polyorganosiloxane (7 A) having a composition identical to that of preparation (4 A) was produced on the basis of the polymer/filler dispersion (7) and this had a viscosity of 18,000 mPa·s.

450 parts of the polyorganosiloxane preparation (7 A) were mixed with 50 parts of the polyorganosiloxane preparation (7 B) which was identical to the polyorganosiloxane preparation (4 B).

The catalyzed mixture had a viscosity of 12,000 mPa·s and a processing time of 133 minutes. The mechanical properties are shown in Table 2.

### Example 8 Comparative Example)

A mixture of 1750 g of an α,ω-bis(vinyldimethylsiloxy)polydimethyl-siloxane having a viscosity of 1000 mPa·s and a residual SiOH content of 10 ppm and 1750 g of an α,ω-bis(vinyldimethylsiloxy)polydimethylsiloxane having a viscosity of 1000 mPa·s and a residual SiOH content of 200 ppm was mixed with 45 g of water and 45 g of hexamethyldisilazane in the kneader under a stream of inert gas. Without heating or cooling, a total of 2450 g of an untreated pyrogenic silica having a BET surface area of 140 m²/g were incorporated a little at a time over a period of 40 minutes. After the addition of the filler was complete, a further 330 g of hexamethyldisilazane were added, and the mixture was then kneaded for one hour without heating or cooling, with the composition reaching a temperature of 55° C. The mixture was subsequently heated at 150° C. in a stream of inert gas for three hours, and was then cooled to 90° C. Finally, 2600 g of an α,ω-dihydropolydimethylsiloxane having a viscosity of 1000 mPa·s and an H content of 120 ppm were mixed in. The polymer/filler dispersion (8) had a viscosity of 29,000 mPa·s.

An addition-crosslinking polyorganosiloxane preparation (8 A) having a composition identical to that of preparation (4 A) was produced on the basis of the polymer/filler dispersion (8), and this had a viscosity of 10,000 mPa·s.

450 parts of the polyorganosiloxane preparation (8 A) were mixed with 50 parts of the polyorganosiloxane preparation (8 B) which was identical to the polyorganosiloxane preparation (4 B).

The catalyzed mixture had a viscosity of 7000 mPa·s and a processing time of 93 minutes. The mechanical properties are shown in Table 2.

### Example 9 (Comparative Example)

A mixture of 1750 g of an α,ω-bis(vinyldimethylsilbxy)poly-dimethyl-siloxane having a viscosity of 1000 mPa·s and a residual SiOH content of 10 ppm and 1750 g of an α,ω-bis(vinyldimethylsiloxy)polydimethylsiloxane having a viscosity of 1000 mPa·s and a residual SiOH content of 200 ppm was mixed with 75 g of an α,ω-dihydroxypolydimethylsiloxane having a viscosity of 40 mPa·s and an OH content of 39,000 ppm in the kneader under a stream of inert gas. Without heating or cooling, a total of 2450 g of an untreated pyrogenic silica having a BET surface area of 140 m²/g were incorporated a little at a time over a period of 45 minutes. After the addition of the filler was complete, the mixture was kneaded for one hour without heating or cooling, with the composition reaching a temperature of 105° C. The mixture was subsequently heated at 150° C. in a stream of inert gas for one hour, and was then cooled to 90° C. Finally, 2600 g of an α,ω-dihydropolydimethylsiloxane having a viscosity of 1000 mPa·s and an H content of 120 ppm were mixed in. The polymer/filler dispersion (9) had a viscosity of 800,000 mPa·s.

An addition-crosslinking polyorganosiloxane preparation (9 A) having a composition identical to that of preparation (4 A) was produced on the basis of the polymer/filler dispersion (9), and this was too thixotropic for a viscosity measurement.

450 parts of the polyorganosiloxane preparation (9 A) were mixed with 50 parts of the polyorganosiloxane preparation (9 B) which was identical to the polyorganosiloxane preparation (4 B).

The catalyzed mixture was likewise too thixotropic for a viscosity measurement.

### Example 10 (Comparative Example)

A mixture of 3500 g of an α,ω-dihydroxypolydimethylsiloxane having a viscosity of 80 mPa·s and an OH content of 8000 ppm with 44 g of 1,3-divinyl-1,1,3,3-tetramethyldisiloxane and 60 g of a 65% aqueous solution of KOH was placed in the kneader under a stream of inert gas. While applying full heating, a total of 2450 g of an untreated pyrogenic silica having a BET surface area of 140 m²/g were incorporated a little at a time over a period of 45 minutes. After the addition of the filler was complete, the mixture was kneaded while heating for one hour, with the composition reaching a temperature of 140° C. After a cooling phase until a mixing temperature of 120° C. had been reached, 50 g of formic acid were mixed in in two equal portions. After kneading without cooling for one hour, the mixture was heated at 150° C. in a stream of inert gas for two hours, and was then cooled to 120° C. Finally, 2600 g of an α,ω-dihydropolydimethylsiloxane having a viscosity of 1000 mPa·s and an H content of 120 ppm were mixed in. The polymer/filler dispersion (10) had a viscosity of 1,100,000 mPa·s.

An addition-crosslinking polyorganosiloxane preparation (10 A) having a composition identical to that of preparation (4 A) was produced on the basis of the polymer/filler dispersion (10), and this was too thixotropic for a viscosity measurement.

450 parts of the polyorganosiloxane preparation (10 A) were mixed with 50 parts of the polyorganosiloxane preparation (10 B) which was identical to the polyorganosiloxane preparation (4 B).

The catalyzed mixture was likewise too thixotropic for a viscosity measurement.

The mechanical properties are shown in Table 2.

TABLE 2

| | Dynamic viscosity | | Dynamic | | | | |
|---|---|---|---|---|---|---|---|
| | of polymer/filler | Dynamic | viscosity of | Shore A | Tensile | Elongation | Tear strength |
| | dispersion | viscosity of | A + B (9:1) | Hardness | strength | at break | (strip specimen) |
| Example | [mPa · s] | A [mPa · s] | [mPa · s] | [points] | [N/mm²] | [%] | [N/mm] |
| 4 | 52,000 | 23,000 | 15,000 | 33 | 5.6 | 350 | 5.2 |
| 5 | 41,000 | 19,500 | 14,000 | 33 | 4.8 | 320 | 5.3 |
| 6* | 134,000 | 38,000 | 26,000 | 19 | 5.8 | 890 | 9 |
| 7* | 58,000 | 18,000 | 12,000 | 19 | 5.4 | 790 | 8.5 |
| 8* | 29,000 | 10,000 | 7000 | 22 | 5.2 | 560 | 7 |

| | | | | | | |
|---|---|---|---|---|---|---|
| 9* | 800,000 | thixotropic, not measurable | 27 | 6.5 | 710 | 7.5 |

| | | | |
|---|---|---|---|
| 10* | 1,100,000 | thixotropic, not measurable | sticky gel; not measurable |

*comparative example

The polyorganosiloxane preparations 4 A, 5 A, 6 A, 7 A, 8 A, 9 A and 10 A were each admixed with a polar additive in an effective concentration. One minute after addition of the additive, the viscosity was measured (Table 2a).

TABLE 2a

| | Viscosity [mPa · s] | | | | | | |
|---|---|---|---|---|---|---|---|
| | Examples | | Comparative examples | | | | |
| Additive added | 4A | 5A | 6A | 7A | 8A | 9A | 10A |
| None | 23,000 | 19,500 | 38,000 | 18000 | 10,000 | 1) | 1) |
| Antistatic 3*(2%) | 22,500 | 20,500 | 1) | 1) | 1) | 1) | 2) |
| Antistatic 4** (2%) | 21,500 | 17,000 | 1) | 1) | 1) | 1) | 2) |
| Bonding agent 5*** (2%) | 19,000 | 16,000 | 1) | 1) | 1) | 1) | 2) |
| Bonding agent 6**** (3%) | 1700 | 15,000 | 1) | 1) | 1) | 1) | 2) |
| Release agent 7***** (5%) | 21,500 | 18,500 | 1) | 1) | 1) | 1) | 2) |

*HO(C₂H₄O)₁₀(CH₂)₃(CH₃)₂SiO[(CH₃)₂SiO]₁₅(CH₃)₂SiO(CH₂)₃(OC₂H₄)₁₀OH
**(CH₂═CH)(CH₃)₂SiO—[(CH₃)₂SiO]_{˜45}—[R(CH₃)SiO]_{˜8}SiO(CH₃)₂(CH═CH₂)R═(CH₂)₃(OC₂H₄)₄OCH₃
***3-(2,3-epoxypropoxy)propyltrimethoxysilane
****γ-methacryloxypropyltrimethoxysilane
*****α,ω-bis(trimethylsiloxy)polyphenylmethylsiloxane having a viscosity of 200 mPa · s
1) non-sag/not measurable
2) non-sag even without polar additive/not measurable

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A flowable, crosslinkable polyorganosiloxane composition comprising
(A) at least one suspension of reinforcing fillers in polyorganosiloxanes,
(B) at least one crosslinking system selected from the group consisting of condensation- and addition-crosslinking systems
(C) at least one corresponding crosslinking catalyst, and
(D) optionally one or more polar additives.
wherein the suspension (A) is obtained by
(1) mixing of a
(X) polyorganosiloxane having a viscosity at 23° C. of from 100 to 500,000 mPa·s or a mixture of such polyorganosiloxanes with
(Y) water, with the proviso that the total amount of water is introduced into the mixture separately or all or in part as a constituent of the condensation/equilibration catalyst (Z) or, in the adsorbed state, via the reinforcing filler (F) and
(Z) a substance effective as condensation/equilibration catalyst or a mixture of such substances to form a mixture,
(2) optionally equilibrating the mixture at elevated temperature, preferably from 50° C. to 180° C., for a period of from 15 to 120 minutes,
(3) adding a reinforcing filler (F) having a specific surface area (BET) of at least 40 m²/g,
(4) reacting the mixture at elevated temperature, preferably from 50° C. to 180° C.,
(5) deactivating the catalyst (Z) by addition of one or more deactivating agents (DA),
(6) removing volatile constituents by heating in a stream of inert gas and/or under reduced pressure in the temperature range from 80° C. to 180° C., and
(7) optionally adding a further polysiloxane (XX) or a mixture of polysiloxanes.

2. The polyorganosiloxane composition of claim 1, wherein the polyorganosiloxanes (X) as constituent of the suspension (A) comprise units of the general formula (I)
RₐSiO_{(4-a)/2} (I)
where
the radicals R are identical or different monovalent, Si—C-bonded, substituted or unsubstituted C₁-C₁₈-hydrocarbon radicals or a hydroxyl radical and
a is 0, 1, 2 or 3,
with the proviso that R is not a radical which is reactive in the presence of the condensation/equilibration catalyst used if these radicals are present in a concentration of >1000 ppm, based on the total amount of the polyorganosiloxanes (X).

3. The polyorganosiloxane composition of claim 1, wherein the polyorganosiloxanes (X) have a viscosity at 23° C. of from 100 to 500,000 mPa·s.

4. The polyorganosiloxane composition of claim 1, wherein polyorganosiloxanes (X) of the general formula (II)
(R¹)ₓ(R²)₃₋ₓ SiO[Si(R²)₂O]ₘ [Si(R²)(R¹)O]ₘ Si(R²)₃₋ₓ(R¹)ₓ (II)
where
the radicals R¹ are identical or different monovalent, SiC-bonded, unsaturated C₁-C₈-alkyl radicals,
the radicals R² are identical or different monovalent, SiC-bonded, substituted or unsubstituted saturated C₁-C₈-alkyl radicals, substituted or unsubstituted C₁-C₈-aryl radicals, or the hydroxyl radical
m is from 100 to 1200,
n is 0 or from 1 to 50, and
x is 0 or from 1 to 3,
are used as polyorganosiloxanes (X).

5. The polyorganosiloxane composition of claim 1, wherein at least one catalyst (Z) is selected from the group consisting of carboxylic acids, optionally in combination with their quaternary ammonium salts, sulfonic acids of the formula XSO₃H, where X is alkyl, aryl, alkaryl or halogen, secondary and tertiary alkylamines, alkylsulfonium silanolates, alkali metal oxides, hydroxides, alkoxides, silanolates, quaternary ammonium and phosphonium compounds.

6. The polyorganosiloxane composition of claim 1, which comprises, as further constituent of the suspension (A), polyorganosiloxanes (XX) comprising units of the general formula (III)
RₐSiO_{(4-a)/2} (III)
where
the radicals R are identical or different monovalent, SiC-bonded, substituted or unsubstituted C₁-C₁₈-hydrocarbon radicals, the hydroxyl radical or hydrogen radical and
a is 0, 1, 2 or 3.

7. The polyorganosiloxane composition of claim 1, which comprises, as polyorganosiloxanes (XX), polydiorganosiloxanes of the general formula (IV)
(R¹)ₓ(R²)₃₋ₓ SiO[Si(R²)₂O]ₘ [Si(R²)(R¹)O]ₙ Si(R²)₃₋ₓ(R¹)ₓ (IV)
where
the radicals R¹ are identical or different monovalent, SiC-bonded, unsaturated C₁-C₈-alkyl radicals, condensable or hydrolyzable radicals,
the radicals R² are identical or different monovalent, SiC-bonded, substituted or unsubstituted saturated C₁-C₁₈-alkyl radicals, substituted or unsubstituted C₁-C₁₈-aryl radicals,
m is 0 or from 1 to 1500,
n is 0 or from 1 to 50
x is 0 or from 1 to 3.

8. A process for producing flowable, crosslinkable polyorganosiloxane compositions comprising
(A) at least one suspension of reinforcing fillers in polyorganosiloxanes,
(B) at least one crosslinking system selected from the group consisting of condensation- and addition-crosslinking systems
(C) at least one corresponding crosslinking catalyst, and
(D) optionally one or more polar additives,
wherein the suspension (A) is obtained by
(1) mixing of a
(X) polyorganosiloxane having a viscosity at 23° C. of from 100 to 500,000 mPa·s or a mixture of such polyorganosiloxanes with
(Y) water, with the proviso that the total amount added can be introduced into the mixture either separately or else, in whole or in part as a constituent of the condensation/equilibration catalyst (Z) or, in the adsorbed state, via the reinforcing filler (F) and
(Z) a substance effective as condensation/equilibration catalyst or a mixture of such substances to form a mixture,
(2) optionally equilibrating the mixture at elevated temperature, for a period of from 15 to 120 minutes,
(3) adding a reinforcing filler (F) having a specific surface area (BET) of at least 40 m²/g,
(4) reacting the mixture at elevated temperature,
(5) deactivating the catalyst (Z) by addition of one or more deactivating agents (DA),
(6) removing volatile constituents by heating in a stream of inert gas and/or under reduced pressure in the temperature range from 80° C. to 180° C. and
(7) optionally adding a further polysiloxane (XX) or a mixture of polysiloxanes.

9. The process of claim 8, wherein the mixing of the polyorganosiloxane (X), the water (Y) and the condensation/equilibration catalyst (Z) in step (1) and optionally equilibrating of this mixture in step (2) are carried out in the same mixing apparatus in which the addition in step (3) and the in-situ treatment in step (4) of the reinforcing filler (F), and the deactivating of the catalyst (Z) in step (5) and optionally the addition of a further polyorganosiloxane (XX) or a mixture of polyorganosiloxanes in step (7) are carried out subsequently.

10. The process of claim 8, wherein the crosslinking polyorganosiloxane compositions are produced by mixing
(AA) the suspension (A) prepared by the process of claim 8, the suspension optionally further comprising polyorganosiloxane (XX) which optionally bear condensable or hydrolyzable groups as in the general formula (IV),
(R¹)ₓ(R²)₃₋ₓ SiO[Si(R²)₂O]ₘ [Si(R²)(R¹)O]ₙ Si(R²)₃₋ₓ(R²)₃₋ₓ (IV)
where
the radicals R¹ are identical or different monovalent, SiC-bonded, unsaturated C₁-C₈-alkyl radicals, condensable or hydrolyzable radicals, the radicals R² are identical or different monovalent, SiC-bonded, substituted or unsubstituted saturated C₁-C₁₈-alkyl radicals, substituted or unsubstituted C₁-C₁₈-aryl radicals,
m is 0 or from 1 to 1500,
n is 0 or from 1 to 50,
x is 0 or from 1 to 3,
(BB) optionally a polyorganosiloxane or a mixture of a plurality of polyorganosiloxanes (XX) which bear(s) condensable or hydrolyzable groups of the formula (IV), with the formulation constituent (BB) being obligatory when (AA) comprises no polyorganosiloxane (XX) which bears condensable or hydrolyzable groups of formula (IV),
(CC) optionally one or more crosslinkers selected from among
an organosilane of the general formula
R²_{4-b} SiR¹_{b} (V),
where
the radicals R¹ can be identical or different and can be the same hydrolyzable radicals R¹ as in the general formula (IV),
the radicals R² can be identical or different and can be the same radicals R² as in the general formula (IV) and b is an integer from 2 to 4,
one or more partially hydrolyzed reaction products of organosilanes of the general formula (V),
with the formulation constituent (CC) being obligatory when the polyorganosiloxane (XX) present in the formulation constituent (AA) or (BB) is a hydroxy-functional polyorganosiloxane, preferably an α,ω-dihydroxypolyorganosiloxane,
(DD) a crosslinking catalyst effective in the condensation system
(EE) optionally a polyorganosiloxane or a mixture of a plurality of polyorganosiloxanes (XX) which bear(s) no condensable or hydrolyzable groups as in the general formula (IV), preferably an α,ω-bis(trialkylsiloxy)polyorganosiloxane, with the trialkylsiloxy radical preferably being a trimethylsiloxy or vinyldimethylsiloxy radical,
(FF) optionally one or more nonreinforcing or partially reinforcing fillers,
(GG) optionally one or more polar additives, and
(HH) optionally water.

11. The process of claim 8, wherein the crosslinking polyorganosiloxane compositions are produced by mixing
(AAA) the suspension (A) obtainable by the process of claim 8 or 9, with the suspension optionally comprising polyorganosiloxane (X) which optionally bears identical or different monovalent, SiC-bonded, unsaturated C₁-C₈-alkyl radicals, of the general formula (IV), or optionally, comprising polyorganosiloxane (XX) which optionally bear identical or different monovalent, SiC-bonded, unsaturated C₁-C₈-alkyl radicals, of the general formula (IV), or hydrogen radicals,
(BBB) optionally a polyorganosiloxane (XX) or a mixture of a plurality of polyorganosiloxanes (XX) which bear identical or different monovalent, SiC-bonded, unsaturated C₁-C₈-alkyl radicals, of the general formula (IV), with the formulation constituent (BBB) being obligatory when (AAA) contains no polyorganosiloxane (X) which bears identical or different monovalent, SiC-bonded, unsaturated C₁-C₈-alkyl radicals, of the general formula (IV), or contains no polyorganosiloxane (XX) which bears identical or different monovalent, SiC-bonded, unsaturated C₁-C₈-alkyl radicals as in the general formula (IV),
(CCC) optionally one or more crosslinkers selected from among organohydrogenpolysiloxanes of the general formula
R′_{b}H_{c}SiO_{(4-b-c)/4} (VII),
where
the radicals R′ are, in each case for themselves independently of one another, radicals R² as in the general formula (IV)
b is from 0.6 to 2.3 and
c is from 0.005 to 1.3
with the proviso that the sum (b+c) is from 0.8 to 2.7 and the organohydrogenpolysiloxane of the general formula (VII) has at least two Si-bonded hydrogen radicals in each molecule, with the formulation constituent (CCC) being obligatory when the polyorganosiloxane (XX) present in the formulation constituent (AAA) is not an organohydrogenpolysiloxane, and the molar ratio of the Si—H groups in the crosslinker (CCC) and optionally in the polyorganosiloxane (XX) as constituent of the suspension (A) to the alkenyl groups in the formulation constituents (AAA) and optionally (BBB) is from 0.3 to 10, preferably from 0.5 to 5,
(DDD) a crosslinking catalyst which is effective in the addition system,
(EEE) optionally a polyorganosiloxane or a mixture of a plurality of polyorganosiloxanes (XX) which bear(s) no condensable hydrolyzable groups, of the general formula (IV),
(FFF) optionally one or more nonreinforcing or partially reinforcing fillers, and
(GGG) optionally one or more polar additives.

12. The process of claim 8, wherein the crosslinker (CCC) is selected from the group consisting of linear, branched or cyclic organohydrogenpolysiloxanes of the formulae (VIII), (IX) and (X)
H_{y}(R″)_{3-y}SiO[Si(R″)₂O]ₘ [SiH(R″)O]ₙ Si(R″)_{3-y}H_{y} (VIII)
[Si(R″)₂O]ₚ [SiH(R″)O]_{q} (IX)
[(R″)₃₋ᵣHᵣSiO]_{z}SiHₛ(R″)_{4-s-z} (X)
where
the radicals R″ are identical or different monovalent, SiC-bonded, substituted or unsubstituted, saturated or unsaturated C₁-C₈-alkyl radicals, or substituted or unsubstituted C₁-C₈-aryl radicals,
m is 0 or from 1 to 300,
n is 0 or from 1 to 100,
p is 0 or from 1 to 6,
q is from 2 to 8,
r is from 1 to 2,
s is 0 or 1,
y is O or from 1 to 2,
z is from 2 to 4.
